(19) United States
(12) Patent Application Publication
(10) Pub. No.: US 2026/0290323 A1
(43) Pub. Date: Sep. 24, 2026

(54) SYSTEM

(71) Applicant: SoftBank Group Corp., Tokyo (JP)

(72) Inventor: Natsuki KODA, Tokyo (JP)

(73) Assignee: SoftBank Group Corp., Tokyo (JP)

(21) Appl. No.: 19/558,644

(22) Filed: Mar. 6, 2026

(30) Foreign Application Priority Data
Mar. 19, 2025 (JP) 2025-044512

(51) Int. Cl. G10L 15/16; G06N 3/0475; G10L 13/04

(52) U.S. Cl. CPC G10L 15/16; G06N 3/0475; G10L 13/04

(57) ABSTRACT

A system includes a processor that is configured to convert a voice input of a user into a digital format and transmit the digital format to a speech recognition engine, convert and analyze audio data from the speech recognition engine into text data, generate, based on the analyzed text data, a prompt sentence for instructing a generative artificial intelligence model to perform a specific operation, and provide an optimal option based on an output of the generative artificial intelligence model.

### CROSS-REFERENCE TO RELATED APPLICATION

This application is based on and claims priority under 35 USC 119 from Japanese Patent Application No. 2025-044512 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that interact with users through speech recognition often stop at merely converting voice input into text and performing simple command execution or keyword-based search. In such systems, a user, particularly an elderly user or a user unfamiliar with information technology, is required to issue explicit and precise commands, or to operate a keyboard or touch interface to refine search conditions, select options, or trigger complex system functions. As a result, the user experience is degraded, and it is difficult for the user to obtain an optimal option that truly matches the user's underlying intent in a simple and natural manner.

Furthermore, existing voice interfaces generally do not effectively leverage generative artificial intelligence models to interpret the semantics and context of user utterances and to generate flexible instructions to downstream services. Consequently, it is challenging to automatically generate prompts suitable for generative artificial intelligence models based on recognized text and to use outputs of such models to provide optimal options across various services, including information retrieval tools and location information providing devices. Accordingly, there is a need for a system that can, on the basis of a voice input provided by a user without the use of a keyboard, convert the voice input into digital audio, recognize and analyze the corresponding text, automatically generate an appropriate prompt sentence for instructing a generative artificial intelligence model to perform a specific operation, and ultimately provide the user with an optimal option adapted to different services.

### SUMMARY

In order to solve the above problems, a system according to one aspect of the present invention comprises a processor, wherein the processor is configured to convert a voice input of a user into a digital format and transmit the digital format to a speech recognition engine, convert and analyze audio data from the speech recognition engine into text data, generate, based on the analyzed text data, a prompt sentence for instructing a generative artificial intelligence model to perform a specific operation, and provide an optimal option based on an output of the generative artificial intelligence model.

In this system, the processor is further configured to provide an interface that allows the user to perform the voice input without using a keyboard. By doing so, even an elderly user or a user unfamiliar with information technology can naturally provide requests and instructions through voice only, while the processor handles digital conversion, speech recognition, text analysis, and prompt generation in an integrated manner.

Moreover, the processor is configured to provide the optimal option so as to be applicable to services including an information retrieval tool and a location information providing device. By using the prompt sentence to appropriately control the generative artificial intelligence model, and by interpreting the model's output in the context of external services, the processor can present, for example, search results or nearby locations as optimal options that correspond to the user's recognized intent. Thus, the system enables automatic, context-aware provision of optimal options across a variety of services based on natural voice input from the user.

The term “system” refers to a combination of hardware and software components, including at least one processor, configured to execute the processing described in the claims.

The term “processor” refers to one or more processing circuits, such as a CPU, GPU, microcontroller, or dedicated hardware logic, capable of executing instructions to perform the functions specified in the claims.

The term “voice input” refers to an audio signal generated by speech uttered by a user and captured by an input device such as a microphone.

The term “digital format” refers to a representation of the voice input as digital audio data, including, for example, pulse-code modulated (PCM) data or compressed audio data.

The term “speech recognition engine” refers to a software and/or hardware module that receives digital audio data and outputs text data corresponding to recognized speech content.

The term “audio data” refers to data representing sound, including the digital representation of the user's voice input that is processed by the speech recognition engine.

The term “text data” refers to a sequence of characters, words, or sentences generated as a recognition result by the speech recognition engine from the audio data.

The term “analyze” refers to processing the text data to extract linguistic, semantic, or contextual information, including but not limited to tokenization, parsing, keyword extraction, and intent identification.

The term “prompt sentence” refers to a text instruction generated by the processor, based on the analyzed text data, for controlling a generative artificial intelligence model to perform a specific operation.

The term “generative artificial intelligence model” refers to a machine learning model, such as a large language model or similar generative model, that generates text or other outputs in response to an input prompt.

The term “specific operation” refers to a defined processing task to be performed by the generative artificial intelligence model or by a downstream service under the control of a prompt, including, for example, information retrieval, content generation, or option selection.

The term “optimal option” refers to one or more results, selections, or recommendations determined by the processor, based on an output of the generative artificial intelligence model, as being most suitable for the user's intent or request.

The term “interface” refers to a user interaction mechanism, including software and hardware components, that allows the user to provide voice input and to receive outputs such as the optimal option, without requiring the use of a keyboard.

The term “information retrieval tool” refers to a service or application that searches and provides information from one or more data sources, such as web search engines, document databases, or knowledge bases, in response to a query.

The term “location information providing device” refers to a device or service that acquires, manages, or supplies geographic or positional information, including, for example, navigation systems, map services, or GPS-based location services.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

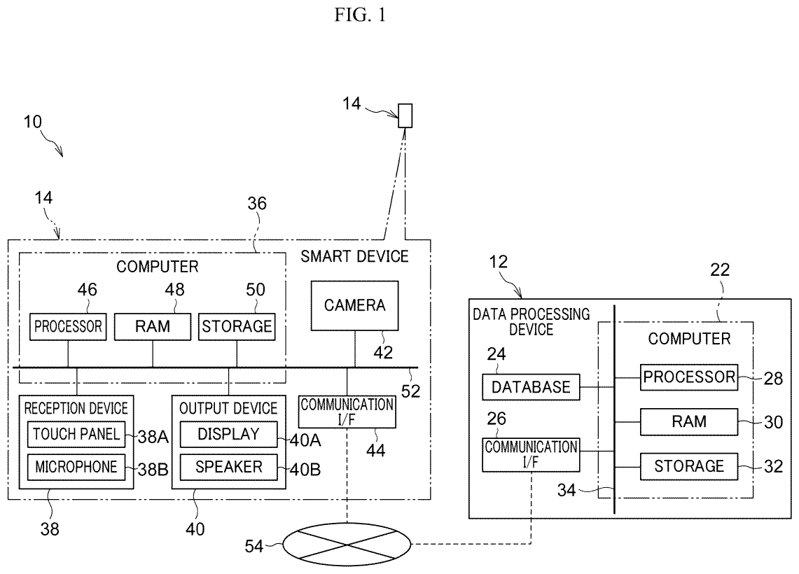

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

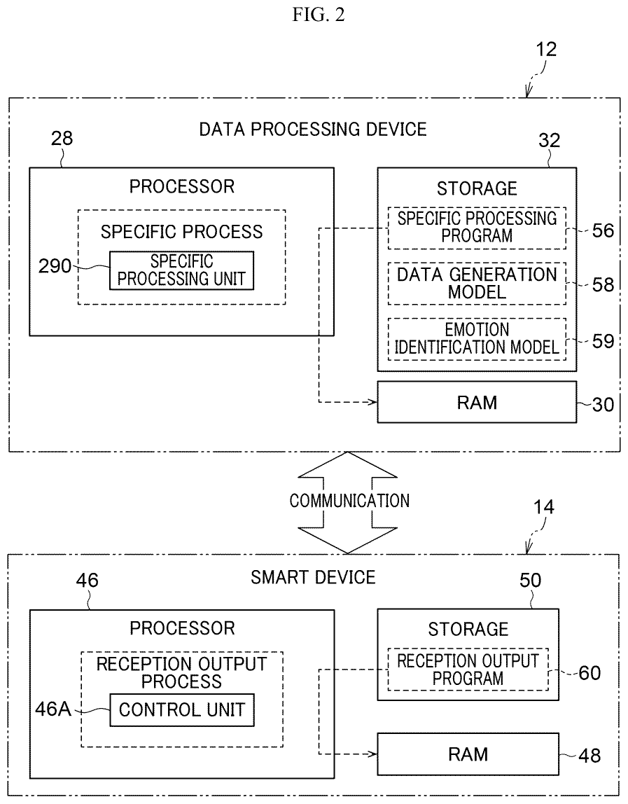

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional voice-based interfaces typically perform speech-to-text conversion and then pass the resulting text to a general-purpose application or service. In many cases, the speech recognition component, the natural language processing component, and downstream service components (such as search or guidance services) are loosely coupled and operate as separate black boxes. As a result, these systems suffer from several technical limitations in terms of computer technology itself.

First, conventional systems do not tightly integrate speech recognition and generative language processing in a way that systematically structures the recognized text into a prompt sentence specifically optimized for a generative AI model. The lack of a dedicated prompt-generation control layer between the speech recognition engine and the generative AI model leads to suboptimal use of model capacity, unnecessary network calls, and redundant post-processing. This can cause increased latency, higher computational load, and inconsistent response quality.

Second, typical systems that support hands-free operation still rely on explicit user interface flows or hidden text input assumptions, and they are not configured to use voice input as the single, unified trigger that initiates and controls an entire processing pipeline. This creates friction in scenarios where users, especially users unfamiliar with information technology or users with limited motor skills, require a fully keyboardless and simplified interface. From a technical standpoint, separate control paths for voice and text input increase complexity in the input handling logic and make state management and resource scheduling less efficient.

Third, conventional information-providing systems do not dynamically adapt the prompt content to user attribute information, spatial location information, or service type information at the system level. They frequently treat such contextual data as optional add-ons handled by individual services. This results in fragmented logic across different modules, duplicated data transformations, and inefficient use of computational resources. It also makes it difficult to produce consistent, context-aware responses for specialized user groups such as elderly users, and reduces the overall robustness of the system as a computing platform.

Fourth, while some systems integrate search, route guidance, and facility guidance functions, they often process each function independently and then later aggregate results in an ad-hoc manner. This fragmented architecture leads to repeated parsing of the same user query, multiple separate calls to backend services, and redundant data formatting operations. Consequently, system throughput is reduced, memory usage is increased, and latency becomes unpredictable, particularly under high load.

Accordingly, there is a need for improvements in computer technology that provide a unified processing architecture in which a processor acquires user voice input, converts it into digital audio data, performs speech recognition to obtain text data, generates a prompt sentence tailored for a generative AI model, combines the generative AI model's response with service-specific processing such as information retrieval or guidance, and presents the result to the user, all under a single voice-interactive control loop. There is also a need for a technical mechanism to incorporate user attributes, spatial location, and service type into prompt generation in a systematic manner, thereby improving processing efficiency, reducing redundancy, and enhancing the quality and consistency of responses generated by the underlying computing system.

The specific processing by the specific processing unit 290 of the data processing device 12 in Example 1 is realized by the following means.

The present invention provides a server comprising a processor configured to acquire a voice input of a user via an acoustic input device, convert the voice input from an analog signal into digital audio data, transmit the digital audio data via a communication path to an information processing apparatus, input the digital audio data to a speech recognition processing unit of the information processing apparatus, and obtain text data resulting from conversion of the digital audio data by the speech recognition processing unit; the processor further being configured to generate, on the basis of the text data, a prompt sentence to be provided to a generative AI model, to input the prompt sentence to the generative AI model, and to obtain response data generated by the generative AI model; the processor further being configured to determine, on the basis of information included in the response data, an optimal option to be provided to the user, and to cause at least one of the response data and the optimal option to be presented to the user in a form of character display by a display device or in a form of voice output by a speech synthesis processing unit; and the processor further being configured to provide a voice-interactive interface that eliminates a need for operation of a character input device by the user and that initiates and controls a series of processes from acquisition of the voice input through presentation of the response using only the voice input, and to control generation of the prompt sentence by adding at least one of user attribute information, spatial location information, and service type information to the text data so as to cause the generative AI model to generate response data suitable for at least one of an information providing service, a guidance service, an information retrieval processing function, a route guidance processing function, and a facility guidance processing function. This enables a tightly integrated, voice-centric processing pipeline in which speech recognition, prompt sentence generation, context-aware invocation of a generative AI model, and downstream information processing are orchestrated by a single processor, thereby reducing redundant data transformations, lowering processing latency, improving consistency and relevance of generated responses, and enhancing the overall efficiency and robustness of the underlying computer system as a platform for hands-free, context-aware information services.

The term “processor” refers to a hardware processing element, such as a central processing unit or other information processing circuitry, that executes instructions to perform data acquisition, data conversion, control, and communication operations in the system.

The term “voice input” refers to acoustic information generated by a user by speaking, which is captured as an analog sound signal by an input device of the system.

The term “acoustic input device” refers to a hardware component, such as a microphone or an array of microphones, that receives sound waves from a user and converts the sound waves into an electrical analog signal.

The term “analog signal” refers to a continuously varying electrical representation of sound that corresponds to the pressure fluctuations of the original acoustic wave.

The term “digital audio data” refers to discrete-time, quantized data representing sound, obtained by sampling and digitizing an analog signal so that it can be processed by an information processing apparatus.

The term “communication path” refers to a logical or physical data transmission medium, including wired or wireless networks, through which digital data is transferred between devices or components of the system.

The term “information processing apparatus” refers to a computing entity, such as a server device or a computing node, that includes hardware and software resources for processing digital data, including performing speech recognition and interaction with a generative AI model.

The term “speech recognition processing unit” refers to a functional component, implemented by hardware, software, or a combination thereof, that receives digital audio data and performs analysis and pattern recognition to convert the digital audio data into text data.

The term “text data” refers to a sequence of characters or symbols representing linguistic content obtained from speech recognition processing of digital audio data.

The term “prompt sentence” refers to a textual instruction or query, constructed on the basis of text data and optionally including additional contextual information, that is provided as input to a generative AI model to cause the model to generate response data.

The term “generative AI model” refers to a trained computational model, such as a generative language model, that receives a prompt sentence as input and produces output data, including natural language responses, by statistically or algorithmically generating new content.

The term “response data” refers to information output by the generative AI model in response to a prompt sentence, including at least a text response and optionally structured data or metadata.

The term “optimal option” refers to a selected result or recommendation derived from the response data and optionally from additional processing, which is determined by the processor as most suitable to be provided to the user according to one or more criteria.

The term “display device” refers to a hardware output component, such as a screen or monitor, that visually presents characters, symbols, or graphical information to the user.

The term “speech synthesis processing unit” refers to a functional component, implemented by hardware, software, or a combination thereof, that converts text data into synthesized digital audio data suitable for output as an audible voice.

The term “voice output” refers to audible information presented to the user, generated by converting text data into synthesized speech and reproducing the synthesized speech through an acoustic output device.

The term “voice-interactive interface” refers to an interaction mechanism in which user input and system control are performed primarily or exclusively through spoken utterances, without requiring manual operation of a character input device.

The term “character input device” refers to an input component, such as a keyboard, keypad, or touch-based character entry interface, that allows a user to input characters or text by manual operation.

The term “user attribute information” refers to data representing characteristics of a user, such as age group, language preference, accessibility needs, or usage history, which may be used to control generation of a prompt sentence or a response.

The term “spatial location information” refers to data indicating a geographic or positional state of a device or user, such as coordinates, address, or region, which may be incorporated into a prompt sentence or used to generate location-dependent responses.

The term “service type information” refers to data indicating a category or kind of service requested or to be provided, such as information provision, guidance, search, route navigation, or facility lookup, which is used to adjust the behavior of the system or the generative AI model.

The term “information providing service” refers to a processing function in which the system obtains, generates, or selects information relevant to a user's query and presents the information to the user in a comprehensible form.

The term “guidance service” refers to a processing function in which the system provides directions, instructions, or advisory content to the user regarding locations, facilities, procedures, or actions.

The term “information retrieval processing function” refers to a function that searches, filters, or retrieves information from one or more data sources, such as databases or external information systems, based on a query derived from user input or response data.

The term “route guidance processing function” refers to a function that generates route information, such as paths, step-by-step directions, or travel options, between locations, and that may be presented to the user as part of an answer.

The term “facility guidance processing function” refers to a function that identifies, selects, or ranks facilities, such as institutions, stores, or service locations, and provides related descriptive or access information to the user.

The term “integrated information providing result” refers to a combined output in which response data from the generative AI model and results of one or more processing functions, such as information retrieval or guidance, are synthesized into a unified result for presentation to the user.

In one or more embodiments, the server, the terminal, and the user cooperate to realize a voice-interactive information providing system in which a processor configures a complete pipeline from acoustic capture to generation and presentation of response data using a generative AI model and a structured prompt sentence.

The terminal includes an acoustic input device, such as a microphone or microphone array, an audio codec, a central processing unit, a memory, a wireless or wired communication interface, a display device, a loudspeaker, and optionally a hardware accelerator for audio processing. The terminal executes an operating system such as a mobile operating system or a general-purpose operating system that provides audio input/output APIs, networking APIs, and user interface frameworks.

The server includes one or more processors such as a central processing unit and optionally one or more accelerators such as graphics processing units. The server further includes a memory, mass storage, and a network interface. In one embodiment, the server runs a server operating system such as a Unix-like operating system and hosts server-side software components including a web application framework, a speech recognition processing unit, a generative AI model execution environment, and an interface manager for coordinating input and output with the terminal.

The user speaks into the acoustic input device of the terminal to supply a voice input. The terminal uses its audio hardware and audio driver software (for example, an audio hardware abstraction layer or a multimedia framework) to convert the analog sound pressure variations into a digital audio stream. The terminal samples the analog signal at a predefined sampling frequency, such as 16 kHz, and quantizes it at a resolution, such as 16 bits per sample, thereby generating digital audio data represented as arrays of integer values stored in memory. The terminal optionally compresses these arrays using an audio compression algorithm, such as a perceptual audio codec or a low-bitrate speech codec, and then transmits the compressed or uncompressed digital audio data over a communication path to the server. The server receives the digital audio data via the network interface and stores it in a buffer managed by the server-side application. The server invokes the speech recognition processing unit. In one embodiment, the server implements the speech recognition processing unit using a deep neural network-based acoustic model combined with a language model. The acoustic model may be a multi-layer neural network, such as a convolutional neural network, a recurrent neural network, a transformer network, or a hybrid thereof. The server converts the raw audio samples into feature vectors, such as Mel-frequency cepstral coefficients or filter bank energies, using digital signal processing operations including windowing, fast Fourier transforms, and filter bank analysis.

The server inputs the feature vectors into the acoustic model and computes, layer by layer, activations that represent probabilities over phonetic units. The server combines these probabilities with a statistical language model or a neural language model to perform decoding, for example using a beam search algorithm, thereby computing a most likely sequence of characters or tokens corresponding to the user's utterance. The server outputs this result as text data, which is stored in a structured data object that includes the recognized string, timing information, and confidence scores.

The server then generates a prompt sentence for a generative AI model on the basis of the text data. The server implements a prompt-generation module as part of the application logic. The server receives the recognized text, user attribute information, spatial location information, and service type information. The server stores these items in data structures, such as key-value maps or objects with defined fields. The server constructs the prompt sentence by concatenating or formatting these fields according to predefined templates.

For example, when the user says “Please tell me today's weather”, the server may generate a prompt sentence such as:
“You are a helpful assistant. Answer in Japanese. Question: Please tell me today's weather”

Alternatively, when the user says “Please tell me where the nearest hospital is” and the system has location and user attribute information, the server may generate a prompt sentence such as:
“You are a local guide for elderly users. Answer in simple Japanese. User location: Tokyo, Shinjuku area. Question: Please tell me where the nearest hospital is”

By embedding user attribute information and spatial location information into the prompt sentence, the server creates a structured and context-rich input for the generative AI model. The server employs rule-based logic and non-conventional prompt assembly procedures that are designed specifically for the architecture of large generative models, such as separating instruction segments, context segments, and user query segments into well-defined sections. This structure is different from a mere transcription of the user's utterance and improves the utilization efficiency of the generative model's internal attention mechanisms.

The server executes the generative AI model using an inference engine running on the server's processor and, in some embodiments, on an accelerator such as a graphics processing unit or a tensor processing unit. In one embodiment, the generative AI model is implemented as a transformer-based neural network comprising an embedding layer, multiple self-attention layers, feedforward layers, and a final output layer that produces probability distributions over a vocabulary of tokens. The server encodes the prompt sentence into token indices and feeds them into the model. Each attention layer computes attention scores between token representations by performing matrix multiplications and normalization operations, and each feedforward layer applies nonlinear transformations to intermediate representations.

The server configures the generative AI model with parameters such as temperature, maximum number of tokens to generate, and nucleus sampling thresholds. The server runs the model in an auto-regressive manner, iteratively selecting the next token based on the probability distribution output by the model and appending the token to the response sequence. The server can apply decoding algorithms that limit repetition and enforce constraints, such as restricting the language to Japanese or limiting the length of the answer. The server obtains response data as a sequence of characters or tokens which it then converts into a text string.

The server may further apply post-processing rules to the response data. The server can impose application-specific constraints, such as adding polite endings for elderly users or truncating redundant explanations. The server can also integrate outputs from auxiliary services, such as information retrieval functions, route guidance functions, or facility guidance functions. For example, when the user asks “Please tell me where the nearest hospital is”, the server may query a spatial database or an external search service with the user's coordinates, receive a list of candidate medical facilities, and then provide these facility names and attributes as additional context in the prompt sentence or as a structured input to an intermediate reasoning step. The generative AI model then generates an explanation that references the retrieved facilities and orders them according to distance or relevance.

The server determines an optimal option to be provided to the user by evaluating the response data and optionally additional metadata. The server can define evaluation criteria that include distance to facilities, operating hours, user preferences, and confidence scores. The server applies algorithmic rules to compute a ranking or selection. The server may store relevant fields in a structured record containing fields such as “facility name”, “distance”, “opening hours”, and “recommended flag”, and then label one or more records as recommended options. This structured evaluation combined with the generative output allows the server to provide a unified and integrated information providing result, in which free-form text and structured selection data are linked.

The terminal receives from the server response data and information indicating at least one optimal option. The terminal uses its user interface framework to render the response text on the display. The terminal updates visual components with the text string and optionally with icons or markers indicating recommended options. The terminal can perform text wrapping, font size adjustment, and color adaptation to improve readability for elderly users. In addition, the terminal may use a text-to-speech engine to synthesize the response text into audio data. The terminal converts the characters into phonetic representations and uses a synthesis model, such as a concatenative synthesizer, a parametric synthesizer, or a neural vocoder, to generate an audio waveform. The terminal then outputs the waveform through the loudspeaker so that the user hears the answer.

In one embodiment, the server stores logs of the text data, prompt sentences, response data, and selected optimal options in a database. The server assigns identifiers to sessions and messages and maintains associations between user attributes and generated responses. This storage structure enables later analysis of system performance, including latency, accuracy of speech recognition, and relevance of generated answers. The server can adjust parameters of the generative AI model and the prompt generation algorithm based on aggregated statistics, thereby improving the technical performance of the system over time.

The server can train the generative AI model or a domain-specific variant thereof using a corpus of prompt-response pairs. The server defines a loss function, such as cross-entropy between predicted token distributions and reference tokens, and performs gradient-based optimization to update model weights. The server may apply data augmentation techniques, such as paraphrasing user questions, injecting synthetic user attributes, or varying location descriptions, to increase robustness. The server may also fine-tune the model on dialogues involving elderly users, emphasizing clear and concise responses. By designing the training data and loss functions to penalize overly lengthy or ambiguous outputs, the server causes the model to generate answers that are better suited for constrained devices and limited attention spans, thereby reducing unnecessary token generation and computational cost.

The server can also implement a separate model or module for prompt optimization. For example, the server may maintain a mapping from recognized text patterns to prompt templates and update this mapping using reinforcement signals derived from user feedback or objective metrics such as completion of a task. The server, by adjusting the templates, can reduce the required number of tokens to obtain a relevant answer, decreasing bandwidth consumption between the server and any remote model host and reducing latency.

From a technical standpoint, the described architecture improves computer technology in several ways. The server establishes a single voice-interactive control loop so that the voice input itself triggers and manages the entire sequence from capture to presentation. This reduces the need for separate input pathways and state machines for text and voice, simplifying internal state management and reducing code branching. The system's prompt generation module introduces explicit contextualization (user attributes, location, service type) at the computation level, reducing redundant queries to external services and avoiding repeated parsing of unstructured text by downstream components.

By structuring the prompt sentence into distinct sections and by incorporating structured context, the server causes the generative AI model to converge more quickly to relevant answers, which reduces the number of decoding steps required to reach an adequate result and thus lowers computing time on accelerator hardware. This reduction in tokens directly decreases memory bandwidth stress and energy consumption during neural inference. Furthermore, the integration of information retrieval, route guidance, and facility guidance into the generative pipeline reduces repeated transformations and allows the system to reuse intermediate representations. The server, for example, can avoid performing multiple separate searches by using a unified query representation derived from the recognized text and the contextual fields.

The generative AI model processes data according to internal learned weights and attention patterns that are not merely encoded business rules but represent compressed representations of language patterns, user preferences, and context relations learned during training. The server exploits these learned internal structures by feeding in structured prompt sentences and systematically using model outputs as intermediate computational artifacts. This differs from human manual processing, where a person would read a question, search for information, and improvise an answer. In contrast, the server performs high-dimensional vector operations, parallel matrix multiplications, and probabilistic token selection, which are operations suited for modern hardware and produce technical advantages in reproducibility, speed, and scalability.

The system therefore does not only automate human tasks; it improves the efficiency and reliability of the underlying computing platform. The integrated architecture reduces end-to-end response time, improves recognition and answer accuracy through contextual conditioning, and reduces network and computational load by avoiding redundant or poorly structured model calls. The causal relationship is that the server's specific combination of modules—speech recognition processing unit, prompt generation logic, generative AI model execution, selection algorithm, and presentation control—together with the defined data structures and control flows, reconfigures how data is processed inside the computer system, leading to measurable improvements in latency, throughput, and quality of responses. Multiple variations of the described embodiment are possible. The server may host the speech recognition processing unit locally or may invoke an external recognition service, while still performing the text-to-prompt transformation as described. The generative AI model may reside on the same physical hardware as the server, on a separate computing node, or on a cloud-based inference service. The terminal may be a smartphone, a tablet computer, a dedicated voice assistant device, or an in-vehicle system. In each variation, the server, the terminal, and the user cooperate according to the same technical principles: the terminal captures and outputs audio and visual information, the server performs structured recognition, prompt generation, generative inference, and optimal option determination, and the user interacts through voice only, benefiting from a technically improved, low-latency, and context-aware voice-interactive system.

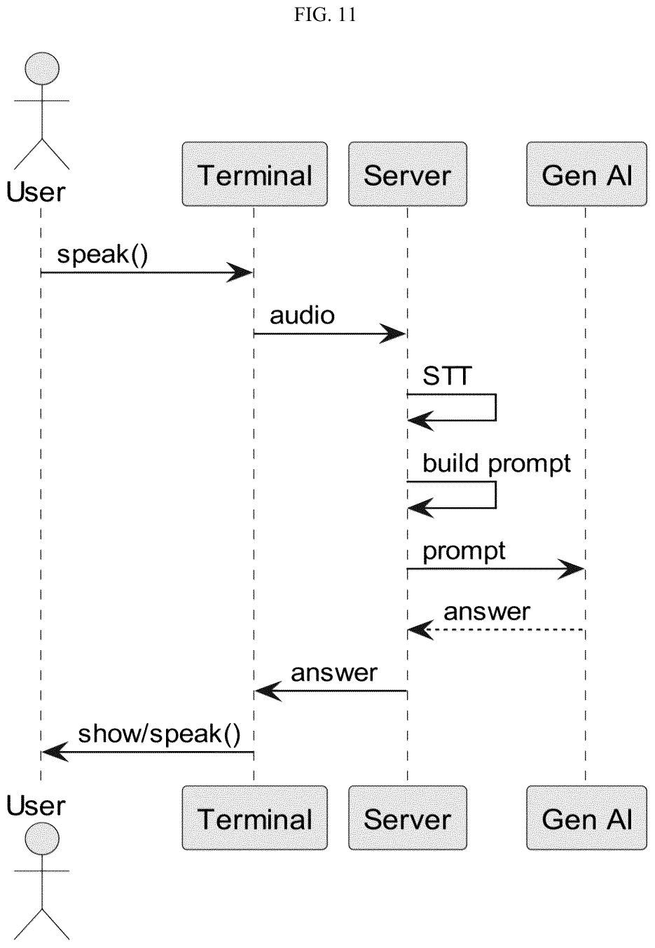

The following describes the processing flow using FIG. 11.

### Step 1

The user provides a voice input toward the terminal.
The user utters a sentence such as “Please tell me today's weather” or “Please tell me where the nearest hospital is” in front of the microphone.
The input in this step is an acoustic sound wave produced by the user.
The output in this step is an analog electrical signal generated by the terminal's acoustic input device corresponding to the user's speech.

### Step 2

The terminal captures and digitizes the analog voice signal.
The terminal uses the microphone and audio codec to sample the analog electrical signal at a predetermined sampling rate (for example, 16 kHz) and quantization (for example, 16-bit resolution), and stores a sequence of samples in memory as digital audio data.
The input in this step is the analog electrical signal from the microphone.
The output in this step is a digital audio buffer, represented as an array of sample values (for example, PCM data), suitable for further processing and transmission.

### Step 3

The terminal optionally compresses the digital audio buffer and prepares it for transmission.
The terminal applies an audio compression algorithm (for example, a speech codec) to the PCM data to generate a compressed bitstream, and then constructs a request message including the compressed or uncompressed digital audio, audio format information, and user or session identifiers.
The input in this step is the raw digital audio buffer generated in Step 2.
The output in this step is a formatted request payload containing audio data and metadata, ready to be sent to the server.

### Step 4

The terminal transmits the audio request payload to the server over a communication path.
The terminal establishes an HTTPS connection, encapsulates the payload in an HTTP request, and sends the request through a network interface such as Wi-Fi or a mobile network to a specified endpoint on the server.
The input in this step is the request payload constructed in Step 3.
The output in this step is a network packet stream containing the request payload delivered to the server's network interface.

### Step 5

The server receives the network packet stream and reconstructs the audio request payload.
The server's network stack reassembles packets into the original HTTP request, parses the headers and body, validates the audio format and size, and stores the audio data in a server-side buffer associated with a session context.
The input in this step is the network packet stream transmitted by the terminal.
The output in this step is a validated server-side representation of the audio request, including the digital audio buffer and associated metadata.

### Step 6

The server performs speech recognition preprocessing on the digital audio buffer.
The server converts the audio buffer into a sequence of feature vectors by applying digital signal processing operations such as framing, windowing, computing short-time Fourier transforms, and converting spectra into features like Mel-frequency cepstral coefficients or filter bank energies.
The input in this step is the digital audio buffer held by the server.
The output in this step is a time-ordered array of numerical feature vectors that represent acoustic characteristics of the user's speech.

### Step 7

The server executes speech recognition to convert feature vectors into text data.
The server inputs the feature vectors to a speech recognition processing unit that may include a neural acoustic model and a language model; the server computes acoustic posterior probabilities, applies decoding (for example, beam search), and determines a most likely sequence of characters or tokens, thereby producing the recognized text of the user's utterance.
The input in this step is the array of acoustic feature vectors from Step 6.
The output in this step is text data, such as the string “Please tell me today's weather” or “Please tell me where the nearest hospital is”, together with recognition confidence scores and timing information.

### Step 8

The server enriches the recognized text with contextual information.
The server retrieves user attribute information (for example, age group, language preference), spatial location information (for example, geographic coordinates, region name), and service type information (for example, weather inquiry, facility search) from a database or session state, and associates these elements with the recognized text in a structured data object.
The input in this step is the recognized text data and stored context data.
The output in this step is a context-augmented query object containing fields for the text, user attributes, location, and service type.

### Step 9

The server generates a prompt sentence for a generative ai model based on the context-augmented query.
The server applies template rules to combine the recognized text and contextual fields into a single prompt sentence, such as “You are a helpful assistant. Answer in Japanese. Question: Please tell me today's weather” or “You are a local guide for elderly users. Answer in simple Japanese. User location: Tokyo, Shinjuku area. Question: Please tell me where the nearest hospital is”.
The input in this step is the context-augmented query object from Step 8.
The output in this step is a structured prompt sentence expressed as a text string that is specifically formatted to be input to the generative AI model.

### Step 10

The server encodes the prompt sentence into tokens suitable for the generative AI model.
The server uses a tokenizer associated with the model to segment the prompt sentence into subword units or tokens and convert each token into a numerical identifier; the server then constructs an ordered token sequence representing the prompt.
The input in this step is the prompt sentence generated in Step 9.
The output in this step is a sequence of token identifiers and corresponding token embeddings ready for neural network inference.

### Step 11

The server performs generative inference with the generative AI model using the token sequence.
The server feeds the token identifiers into the generative AI model, which may be a transformer-based neural network comprising embedding layers, multiple attention layers, and feedforward layers, and the server computes layer-by-layer activations to obtain probability distributions over the vocabulary for each output position, selecting or sampling successive tokens according to configured decoding parameters.
The input in this step is the token sequence representing the prompt sentence.
The output in this step is a generated token sequence corresponding to response text that answers the user's query.

### Step 12

The server decodes the generated token sequence into human-readable response data.
The server converts token identifiers back into text using a detokenization procedure, concatenates characters and subwords, and forms a coherent response sentence, such as “Today's weather is sunny, and some clouds are expected to increase in the afternoon.” or “There is XX Hospital and YY Clinic nearby. XX Hospital provides medical consultations starting at 9:00 a.m.”
The input in this step is the generated token sequence obtained in Step 11.
The output in this step is response data in text form, representing the generative AI model's answer.

### Step 13

The server optionally combines the response data with results from specialized service functions to determine an optimal option.
The server invokes one or more service modules, such as an information retrieval processing function, a route guidance function, or a facility guidance function, merges their structured outputs (for example, facility lists and distances) with the response text, applies selection or ranking algorithms, and flags one or more results as recommended options.
The input in this step is the response data and any structured results from service modules.
The output in this step is an integrated information result that includes both explanatory text and structured data indicating at least one optimal option for the user.

### Step 14

The server constructs a response message to be sent back to the terminal.
The server assembles a response payload including the response text, identifiers of optimal options, and any necessary metadata, and serializes this payload into a format suitable for transmission, such as a structured textual representation.
The input in this step is the integrated information result from Step 13.
The output in this step is a server-side response payload ready for network transmission to the terminal.

### Step 15

The server transmits the response payload to the terminal.
The server uses its network interface and communication stack to send an outbound message containing the response payload over the established or a new HTTPS connection to the terminal's network address.
The input in this step is the constructed response payload from Step 14.
The output in this step is a network packet stream carrying the response information toward the terminal.

### Step 16

The terminal receives and parses the response payload from the server.
The terminal's network stack reassembles the incoming packets, extracts the payload from the message, and deserializes the payload to obtain the response text and any structured data representing optimal options.
The input in this step is the network packet stream transmitted from the server.
The output in this step is an internal data structure on the terminal containing the response text and associated metadata.

### Step 17

The terminal presents the response text visually to the user.
The terminal updates user interface components on the display to show the response text and, if present, highlights any recommended options using visual emphasis such as larger font or icons, thereby generating image data that the display hardware renders.
The input in this step is the parsed response text and optimal option data from Step 16.
The output in this step is a rendered visual presentation on the display that the user can read.

### Step 18

The terminal optionally synthesizes speech from the response text and outputs it audibly.
The terminal passes the response text to a text-to-speech engine, converts the text into phonetic and prosodic features, generates a synthesized audio waveform, and sends the waveform through the audio output path to the loudspeaker, where it is emitted as sound.
The input in this step is the response text from Step 16.
The output in this step is an audible voice output corresponding to the response, which the user can hear.

### Step 19

The user receives the presented information and may initiate a follow-up voice input.
The user reads the text on the display and/or listens to the synthesized speech, understands the provided answer or guidance, and, if needed, formulates a further question and speaks again into the terminal, thereby starting a new iteration of the described processing flow.
The input in this step is the visual and auditory presentation provided by the terminal.
The output in this step is a new acoustic sound wave produced by the user, serving as the next voice input.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional electronic transaction systems that accept voice input merely convert speech to text and then apply simple keyword matching or rule-based processing. Such systems frequently fail to robustly extract transaction parameters, such as product information and transaction amount, when faced with ambient noise, spontaneous speech, disfluencies, or diverse speaking styles of users, including elderly users or users unfamiliar with information technology. As a result, these systems often require users to correct information via a keyboard or touch interface, which undermines accessibility and usability for users who have difficulty with fine motor operations or complex graphical user interfaces.

Furthermore, in many existing architectures, speech recognition, natural language understanding, and payment execution are implemented as loosely coupled, statically configured components. The systems are not designed to adaptively refine extracted parameters or generated messages using advanced machine learning models, such as generative models, based on context and transaction control conditions. This leads to low robustness and limited flexibility when handling ambiguous utterances or incomplete instructions, and it increases the need for repeated user interaction or manual correction. In addition, known systems generally do not optimize internal data flows and processing pipelines for end-to-end voice-based transactions. Specifically, they do not integrate (i) speech-to-text conversion, (ii) semantic extraction of product and payment information, (iii) dynamic generation of model prompts, and (iv) electronic payment execution in a unified control scheme executed by a processor. This lack of integration results in increased latency, inconsistent error handling between components, and higher implementation complexity, thereby degrading the overall performance, reliability, and maintainability of the computer system.

Accordingly, there is a need for a computer-implemented system that improves the underlying computer technology for voice-driven electronic transactions by: reliably converting user voice input into structured transaction parameters without requiring manual text input; adaptively refining extracted information and feedback using a generative model; and tightly integrating these operations with an electronic payment service, so that the processor can execute an efficient, robust, and accessible end-to-end transaction flow suitable even for elderly users.

The specific processing by the specific processing unit 290 of the data processing device 12 in Application Example 1 is realized by the following means.

The present invention provides a server comprising a processor configured to acquire voice input of a user and convert the voice input into a digital signal, transmit the digital signal to an information processing apparatus via a communication path, convert the digital signal into a character string by a speech recognition scheme in the information processing apparatus, extract product information and transaction amount from the character string by a natural language processing scheme, execute a transaction process by using an electronic payment service based on the product information and the transaction amount, generate result information understandable for a user including an elderly person based on a result of the transaction process and present the result information to an output device, generate a prompt sentence for a generative information processing model based on the character string and control conditions relating to the transaction process and transmit the prompt sentence to the generative information processing model, and correct at least one of the product information and the transaction amount or generate the result information based on a response acquired from the generative information processing model. This enables an improved computer-implemented transaction pipeline in which the processor automatically transforms raw voice input into reliable structured payment parameters, adaptively leverages a generative model to enhance extraction accuracy and user feedback, and tightly coordinates these operations with an electronic payment service to execute low-latency, robust, and highly accessible voice-based electronic transactions without requiring manual text input by the user.

The term “processor” refers to a hardware or virtual computation unit, such as a central processing unit or a computation core in a server, that executes instructions to perform data processing operations defined by software.

The term “voice input” refers to sound data representing speech uttered by a user and captured by an input device such as a microphone.

The term “digital signal” refers to an electronic representation of the voice input encoded as discrete numerical values suitable for processing by a computer system.

The term “information processing apparatus” refers to a computer system, including hardware and software components, that performs operations such as speech recognition, natural language processing, and transaction control.

The term “communication path” refers to a logical or physical connection, such as a wired or wireless network, that enables data transfer between the processor and the information processing apparatus.

The term “speech recognition scheme” refers to a computational method or algorithm that converts audio data including speech into text data representing recognized words or sentences.

The term “character string” refers to a sequence of characters encoded in a computer-readable format and representing text obtained from the voice input.

The term “natural language processing scheme” refers to a computational method or algorithm for analyzing and interpreting human language text to extract structured information such as entities, attributes, and intents.

The term “product information” refers to data identifying a commercial item or service, including at least a designation such as a name or category of the item or service.

The term “transaction amount” refers to numerical data indicating a value to be used in a financial transaction, including at least a monetary amount and optionally a currency type.

The term “electronic payment service” refers to a computer-implemented payment platform that processes financial transactions via a data network based on transaction parameters received from an external system.

The term “transaction process” refers to a sequence of operations performed by the processor and the electronic payment service to initiate, authorize, and complete a financial transaction based on the product information and the transaction amount.

The term “result information” refers to data that indicates at least a success or failure status of the transaction process and optionally includes additional descriptive information for presentation to the user.

The term “output device” refers to a hardware component such as a display, speaker, or combination thereof that presents result information to the user in visual or auditory form.

The term “generative information processing model” refers to a machine learning model, such as a generative artificial intelligence model, that produces text or structured data outputs in response to input data including a prompt sentence.

The term “prompt sentence” refers to a text sequence constructed to instruct the generative information processing model to perform a specific operation, such as extracting parameters or generating a response.

The term “control conditions relating to the transaction process” refers to data specifying constraints, rules, or context for executing the transaction, including at least conditions such as allowable ranges of transaction amounts, permitted product types, and security or confirmation requirements.

The term “response acquired from the generative information processing model” refers to output data, including text or structured information, generated by the generative information processing model in reply to a prompt sentence.

The term “user operation screen” refers to a graphical or multimodal interface presented on a display device through which the user provides inputs and receives outputs related to specifying the product information and the transaction amount.

The term “character input device” refers to an input apparatus, such as a keyboard or keypad, configured to receive textual characters from a user.

The term “resource management apparatus” refers to a computer system that stores and manages data records, including at least product records used as candidates for selection.

The term “product candidate” refers to a record representing a possible product to be selected for a transaction, the record including at least an identifier and descriptive information of the product.

The term “usage history information” refers to data indicating past interactions or transactions of the user, including previous product selections, transaction amounts, and times.

The term “attribute information of the user” refers to data describing characteristics of the user, such as demographic information, preferences, or usage patterns, used to influence selection of an optimal product candidate.

In one embodiment, a server cooperates with a terminal to implement a voice-driven electronic transaction system. The server includes at least one processor, a memory storing executable instructions, a network interface, and access to one or more external services. The terminal includes an input device such as a microphone, an output device such as a display and optionally a speaker, a local processor, and a communication interface such as a wireless transceiver.

The terminal acquires voice input from a user through the microphone. The terminal converts the analog audio signal into a digital signal using an audio codec implemented by an operating system audio subsystem, such as a multimedia framework in a mobile operating system. The terminal stores the digital signal in a buffer in main memory and encodes the signal into an audio file format such as a waveform format or a compressed format. The terminal attaches metadata including a sampling rate, bit depth, language code, and a timestamp to the audio file, and the terminal transmits the audio file and the metadata to the server through the communication interface using a network protocol such as a secure hypertext transfer protocol.

The server receives the digital signal via the network interface and temporarily stores it in a storage device such as a magnetic disk device or a solid-state storage device. The server invokes a speech recognition component by sending the audio data and metadata to a speech recognition service. The server may use, for example, a cloud-based speech recognition engine accessible via an application programming interface, which internally uses an acoustic model and a language model. The acoustic model can be a deep neural network, for example, a multi-layer convolutional and recurrent neural network trained on feature vectors such as Mel-frequency cepstral coefficients extracted from audio frames. The language model can be a statistical model or a transformer-based model that maps sequences of phonetic units or characters into sequences of words.

The server receives a recognition result as a text string representing the content of the user's utterance. The server stores this text string in a data structure in working memory, such as a record including fields for the raw recognized sentence, a confidence score, and an identifier referencing the corresponding audio file. By maintaining an association between the audio and the text, the server can later perform error analysis or reprocessing for quality improvement.

The server then performs natural language processing on the text string to extract product information and transaction amount. The server uses a natural language processing library, for example, a library implementing tokenization, part-of-speech tagging, and named-entity recognition. The server converts the text string into a sequence of tokens, assigns a part-of-speech tag to each token, and then applies an entity extraction model. The entity extraction model can be a neural network based on a bidirectional recurrent neural network with a conditional random field layer, or a transformer-based encoder that outputs contextualized embeddings for each token. The server maps these embeddings to label tags indicating semantic roles such as “PRODUCT_NAME,” “AMOUNT_VALUE,” and “CURRENCY_TYPE.”

The server constructs a structured record that includes at least a product_name field, an amount field, and a currency field. The server normalizes numerical expressions by converting localized numerals into standard digits, and the server normalizes currency expressions to a standard code representation. The server also performs validation by checking that the amount falls within a configured range and that the currency is allowed for the current user account. When the utterance is ambiguous or incomplete, the server marks certain fields as low confidence and stores this information in the record for subsequent refinement.

The server uses the structured record to interface with an electronic payment service. The server accesses a payment gateway via a programmatic interface and creates a payment request that includes the amount, currency, product description, and a user identifier. The server transmits this request using a secure channel and receives a response message that includes at least a transaction status, an error code if any, and a transaction identifier. The server writes this transaction data into a persistent storage device, using a database management system. The database record includes fields such as user ID, product_name, amount, currency, transaction status, and timestamps.

The server then generates result information for presentation to the user. The server selects a template sentence based on the transaction status and inserts parameter values such as the product name and the transaction amount. For example, if the transaction is successful, the server generates a result sentence such as: “Your purchase of coffee for 300 yen has been completed successfully.” If the transaction fails, the server generates a sentence such as: “The payment could not be completed. Please check your payment method and try again.” The server transmits this result information to the terminal, and the terminal displays the text on the display in large font suitable for elderly users. Optionally, the terminal uses a text-to-speech function to output the result information as synthesized speech through a speaker, thereby improving accessibility.

In order to improve the robustness and accuracy of the extraction and the quality of the messages, the server uses a generative artificial intelligence model as a generative information processing model. The server prepares a prompt sentence that instructs the model to perform a specific operation on the recognized text or on the structured record. For example, the server may construct a prompt sentence such as:
“You are an assistant for voice-based electronic payments. The user said: ‘Buy coffee for 300 yen.’ Extract the product name and the amount and return them as plain text in the form ‘product_name: . . . , amount: . . . , currency: . . . ’.”

In another use case, the server may generate a prompt sentence such as:
“Rewrite the following transaction result message so that it is simple and easy to understand for an elderly user: ‘The authorization of your payment for coffee in the amount of 300 yen has been completed.’”

The server generates such prompt sentences by concatenating fixed instruction segments with variable parts such as the recognized sentence, internal control conditions, and previous system outputs. The server stores prompt templates and control rules in configuration data structures. The control rules include conditions for when to invoke the generative model, such as when a confidence score falls below a threshold or when a conflict between extracted values and business rules is detected.

The server transmits the prompt sentence to the generative artificial intelligence model. The generative model may be implemented as a large language model based on a transformer architecture with multiple self-attention layers, trained on sequence-to-sequence prediction tasks. The model receives tokens representing the prompt sentence, maps them to embeddings, processes them through the transformer stack, and outputs a sequence of tokens representing the model's response. The server decodes these tokens into a text string.

The server parses the response from the generative model using deterministic parsing rules. For example, when the response is in the form “product_name: coffee, amount: 300, currency: JPY,” the server uses string processing and pattern matching to extract updated values for product_name, amount, and currency. The server compares these values with the original values obtained from the natural language processing scheme. When inconsistencies occur, the server applies a decision rule, such as preferring values that satisfy validation checks or combining values by majority voting across multiple model runs. In this manner, the server uses the generative model not merely to generate natural language, but to refine structured transaction data.

By executing this sequence of operations, the server improves computer technology in several ways. The server reduces the need for repeated network calls and manual corrections by integrating speech recognition, structured information extraction, generative-model-based refinement, and payment execution into a single coordinated pipeline. The server reduces processing latency by maintaining a compact representation of the transaction in memory as a structured record and by avoiding repeated parsing of raw text. The server improves accuracy by combining outputs from a discriminative natural language processing model and a generative model, using explicit confidence metrics and validation rules to reduce extraction errors. The server improves resource usage and communication efficiency by transmitting only necessary fields to the payment service rather than the full original text or audio.

The server also employs specific training and configuration techniques for the generative artificial intelligence model and the natural language processing components. In one implementation, the server uses supervised training data consisting of pairs of utterances and structured transaction records. The server defines a loss function such as a cross-entropy loss for token-level predictions and an additional penalty for incorrect entity values. The server updates model parameters by gradient-based optimization, using a mini-batch procedure and algorithms such as adaptive moment estimation. The server performs data augmentation by synthetically generating variations of utterances, such as rephrasing amounts and product names, to increase robustness to real-world speech patterns. Thus, the models are adapted specifically to the voice-based transaction domain, rather than being generic language models.

In a further embodiment, the server queries a resource management apparatus to resolve product candidates. The server uses product_name as a search key and performs similarity matching using vector representations of product names. The server may use a vector-space model where each product name is mapped into an embedding by a trained encoder. The server calculates a distance metric such as cosine similarity between the uttered product name and product names stored in the database. The server then selects the product record with the highest similarity above a threshold, which yields an “optimal” product candidate. By using embedding-based matching rather than simple string comparison, the server increases matching accuracy for variant expressions, thereby further reducing the need for manual correction.

The terminal provides a user operation screen that is optimized for voice-only input. The terminal displays minimal controls, such as a large “start” button to initiate recording and a large “confirm” button to accept the transaction result. The terminal does not require a keyboard or character input device for specifying the product and amount. Because the server handles complex language understanding and transaction control, the terminal can remain computationally light, reducing local resource usage and simplifying the user interface.

The user interacts with the system through this voice-focused interface. The user, for example, says “I want to buy coffee for 300 yen” to the terminal. The server processes the utterance as described above, executes a payment transaction via the electronic payment service, and returns a concise and clear confirmation message suitable for an elderly user. The server thus enables users who have difficulty operating conventional graphical interfaces to perform electronic transactions reliably and quickly using only speech.

Alternative embodiments are also possible. In one alternative, the server performs speech recognition locally using a speech recognition engine running on the same hardware, instead of using a remote service. In another alternative, the generative artificial intelligence model is hosted on a separate computing node managed by the same service provider, and the server communicates with this node using an internal protocol. In yet another alternative, the server employs different neural network architectures—for example, a sequence-to-sequence recurrent neural network instead of a transformer—for the generative model, or employs different optimization algorithms during training. The same overall system architecture remains, with the server acquiring voice input via the terminal, converting it into structured transaction parameters, optionally refining those parameters using a generative model, and executing an electronic transaction based on the refined data.

Because the server uses these specific data structures, algorithms, and model architectures, the system achieves improved technical performance: higher extraction accuracy due to combined discriminative and generative processing, reduced end-to-end latency due to integrated pipeline control, reduced communication overhead through compact structured messages, and improved robustness to variations in user speech. These improvements are technical enhancements to the underlying computer system, not merely automation of a human clerical task, and they enable voice-based electronic transactions to be carried out efficiently in real time for a broad range of users including elderly users.

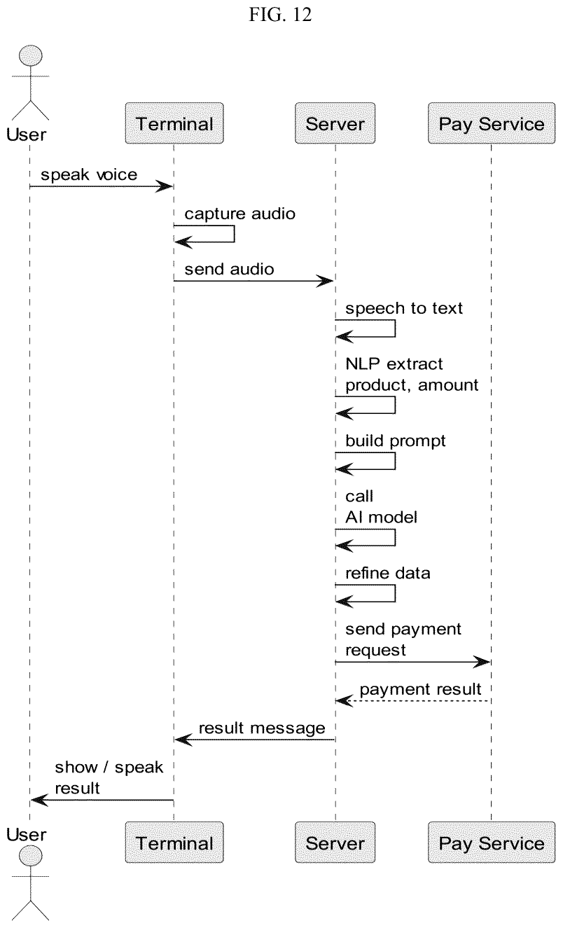

The following describes the processing flow using FIG. 12.

### Step 1

The user provides a spoken transaction instruction to the terminal.
The user speaks into the microphone of the terminal, for example: “Buy coffee for 300 yen.”
The input in this step is an analog audio waveform generated by the user's voice.
The terminal samples the analog signal at a configured sampling rate (for example, 16 kHz), quantizes the samples into digital values (for example, 16-bit integers), and encodes the sampled data into an audio buffer.
The output of this step is a digital audio buffer representing the user's utterance stored in the terminal's memory.

### Step 2

The terminal converts the audio buffer into an audio file and prepares metadata.
The input in this step is the digital audio buffer and configuration parameters such as sampling rate, bit depth, and language code.
The terminal encapsulates the buffer into an audio file format (for example, a waveform or compressed format) by writing a file header and interleaving sample frames according to the codec specification. The terminal also generates metadata including the language code (for example, “ja-JP”), timestamp, and device ID.
The output of this step is a structured audio object consisting of the audio file and associated metadata in terminal storage.

### Step 3

The terminal transmits the audio object to the server via a network.
The input in this step is the audio object (audio file plus metadata).
The terminal opens a secure network connection using a communication protocol (for example, HTTPS) and creates a request payload that embeds the audio file and metadata fields as multipart or binary data. The terminal then sends this payload through its wireless or wired interface to a predefined server endpoint.
The output of this step is a network message delivered to the server that contains the user's audio data and metadata.

### Step 4

The server receives and stores the audio data.
The input in this step is the network message containing the audio file and metadata.
The server validates headers (for example, content type and authentication token), extracts the audio file and metadata from the request body, and writes the audio file to a storage device. The server generates an internal identifier for the audio file and associates the metadata with this identifier in a record stored in memory or in a database.
The output of this step is an internal audio record containing a storage path or pointer, metadata, and a unique identifier.

### Step 5

The server performs speech recognition on the stored audio.
The input in this step is the internal audio record (file path, metadata, identifier).
The server reads the audio file from storage and forwards the binary audio content, along with the language code and recognition parameters, to a speech recognition engine via an application programming interface. The recognition engine computes acoustic features such as Mel-frequency cepstral coefficients from the audio frames, passes them through a trained neural network (for example, a convolutional-recurrent or transformer-based acoustic model), and decodes the output with a language model to produce the most probable text sequence.
The output of this step is a recognition result comprising a text string (for example, “Buy coffee for 300 yen”) and a confidence score, both stored in a recognition result object associated with the audio identifier.

### Step 6

The server performs natural language processing to extract product and amount information.
The input in this step is the recognition result object containing the text string and confidence score.
The server tokenizes the text into words, assigns part-of-speech tags, and passes the token sequence through an entity recognition model (for example, a bidirectional recurrent neural network with a conditional random field output layer or a transformer encoder). The model computes contextual embeddings for each token and classifies each token into semantic labels such as PRODUCT_NAME, AMOUNT_VALUE, or CURRENCY. The server aggregates contiguous tokens with the same label to form entity strings, converts numerical expressions into integers or floating-point numbers, and maps currency words to standardized currency codes.
The output of this step is a structured transaction record containing at least fields for product_name, amount, currency, and associated confidence scores.

### Step 7

The server validates and normalizes the extracted transaction parameters.
The input in this step is the structured transaction record produced in Step 6.
The server checks whether the amount is within configured limits, whether the currency is supported for the user account, and whether the product_name is not empty. The server converts localized numeral formats into a canonical numeric representation and applies rounding rules if necessary. The server also marks fields as high or low confidence based on thresholds applied to the confidence scores.
The output of this step is a validated and normalized transaction record, with flags indicating any low-confidence or invalid fields.

### Step 8

The server optionally refines the transaction record using a generative AI model based on a prompt sentence.
The input in this step is the validated transaction record and the original recognized text string.
The server constructs a prompt sentence by combining fixed instruction phrases with the recognized text and current parameter values, for example: “You are an assistant for voice-based electronic payments. The user said: ‘Buy coffee for 300 yen.’ Extract the product name and the amount and return them as plain text in the form ‘product_name: . . . , amount: . . . , currency: . . . ’.” The server sends this prompt sentence to a generative AI model implemented as a transformer-based language model. The model encodes the prompt into token embeddings, processes them through multiple self-attention and feed-forward layers, and outputs a token sequence representing refined parameter values. The server decodes the sequence into a response string and parses it using deterministic pattern matching to obtain refined product_name, amount, and currency.
The output of this step is an updated transaction record in which one or more fields may be corrected or confirmed based on the generative model's response.

### Step 9

The server resolves the product_name against product candidates in a resource management apparatus.
The input in this step is the transaction record containing the product_name and possibly additional context such as user ID.
The server queries a product database using the product_name as a search key. The server optionally encodes the product_name into a vector embedding using a trained encoder and computes similarity scores between this embedding and embeddings of stored product names. The server ranks the product candidates based on similarity and, optionally, on user-specific usage history and attributes. The server selects the top-ranked product candidate that satisfies predefined constraints and links its product ID, canonical name, and description to the transaction record.
The output of this step is an enriched transaction record including a resolved product ID and final product_name for the transaction.

### Step 10

The server constructs and sends a payment request to an electronic payment service.
The input in this step is the enriched transaction record, which includes product ID, product_name, amount, currency, and user ID.
The server creates a payment request object containing mandatory parameters for the payment service, such as amount, currency code, product description, and a payer identifier or token. The server serializes this object into a request payload and transmits it to the payment service via a secure network protocol. The electronic payment service performs its own internal checks and authorization processes and returns a response object containing a transaction status, transaction identifier, and error information if applicable.
The output of this step is a payment response object stored by the server, linked to the transaction record.

### Step 11

The server generates user-facing result information based on the payment response.
The input in this step is the payment response object together with the transaction record.
The server evaluates the transaction status field in the response and selects a message template according to whether the status indicates success, failure, or pending. The server substitutes parameter values such as product_name and amount into the selected template, for example, generating “Your purchase of coffee for 300 yen has been completed successfully” in case of success, or “The payment could not be completed. Please check your payment method and try again” in case of failure. The server creates a result information object containing the message text, status code, and transaction identifier.
The output of this step is a result information object ready for delivery to the terminal.

### Step 12

The server transmits the result information to the terminal, and the terminal presents it to the user.
The input in this step is the result information object generated in Step 11.
The server serializes the result information into a response payload (for example, in a structured text or data format) and sends it to the terminal over the network. The terminal receives the payload, parses the message text and status, and updates its user interface. The terminal displays the message in large, easily readable text on the display and, if configured, invokes a text-to-speech function to synthesize the message and play it through the speaker.
The output of this step is a visual and/or auditory presentation of the transaction result to the user, enabling the user to confirm completion or recognize a failure and take further action if necessary.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional speech-based interfaces often convert user speech into text and then perform simple keyword matching to trigger predefined actions. Such approaches suffer from several technical problems in computer processing. First, they frequently fail to identify the true intent of the user when the utterance is vague, indirect, or contains multiple concepts, because the system lacks a robust mechanism to derive structured intent information and parameters from natural language input. Second, existing systems typically rely on rigid, rule-based mappings between recognized text and back-end services, which leads to brittle behavior and requires extensive manual tuning whenever new services or use cases are added. Third, when a generative artificial intelligence model is used, many implementations construct prompts in an ad hoc manner from raw text, without leveraging internal intermediate data structures such as extracted keywords, phrases, and contextually relevant external information. This often results in prompts that are noisy, incomplete, or poorly structured, degrading the quality, consistency, and predictability of generated responses. From a computer-technology perspective, these limitations manifest as inefficient use of processing resources, repeated or redundant text analysis steps, and suboptimal coordination between different software components, including speech recognition engines, natural language processing modules, back-end service interfaces, and generative models. In particular, the absence of a unified, processor-level pipeline that (i) systematically transforms speech input into structured intent and parameter representations, (ii) automatically acquires related information from multiple information sources, and (iii) programmatically assembles a meta-information-based prompt for a generative model, leads to increased latency, lower accuracy of intent recognition, and inconsistent user experience across heterogeneous services.

Accordingly, there is a need for a computer-implemented system that improves the technical functioning of speech-driven human-computer interaction by providing a processor-controlled pipeline that integrates speech recognition, natural language processing, intent recognition, information retrieval, and prompt generation for a generative AI model. Such a system should enable the processor to produce, from a given speech input, a well-structured, meta-information-rich prompt that reflects the user's underlying desire and the relevant external and internal data, thereby improving the reliability, efficiency, and adaptability of the overall computing system.

The specific processing by the specific processing unit 290 of the data processing device 12 in Example 2 is realized by the following means.

The present invention provides a server comprising a processor configured to convert speech of a user into digital audio data, to convert the digital audio data into text data by use of a speech recognition engine, to apply a natural language processing algorithm to the text data to extract keywords and phrases, to execute an intent recognition algorithm to estimate intent information and parameter information representing an essence of a desire of the user based on the text data and the extracted keywords and phrases, to obtain related information from at least one of an external information source and an internal information source in accordance with the intent information and the parameter information, to generate a prompt sentence for input to a generative AI model based on meta information including the intent information, the keywords, the phrases, and the related information, to supply the prompt sentence to the generative AI model so as to cause the generative AI model to generate a natural language response sentence, and to transmit at least one of the response sentence and an optimal option determined from the related information toward a terminal for presentation to the user. This enables a technical improvement in computer processing by providing an integrated, processor-controlled pipeline that transforms raw speech into a structured, meta-information-based prompt, thereby enhancing the accuracy and efficiency of intent recognition, reducing redundant processing across modules, improving coordination between service interfaces and the generative AI model, and producing more consistent and contextually appropriate responses within a speech-driven computing environment.

The term “processor” refers to a hardware-implemented data processing unit, such as a central processing unit, a graphics processing unit, or a specialized logic circuit, that executes machine-readable instructions to perform operations including signal processing, data analysis, control of input/output devices, and communication with external components.

The term “server” refers to a computing apparatus, which may be implemented as a physical machine or a virtual machine, configured to provide processing functions, data storage, and network-based services to one or more terminals via a communication network.

The term “terminal” refers to a computing apparatus operated by a user, such as a mobile device, a desktop device, or an embedded device, that includes at least one input unit and at least one output unit and is configured to exchange data with a server over a communication network.

The term “speech of a user” refers to an acoustic signal generated by vocal utterance of a human user, including words, phrases, and sentences, that is capable of being captured by a microphone and processed as audio data.

The term “digital audio data” refers to a sequence of machine-readable values representing sampled and quantized characteristics of an acoustic signal, such as amplitude values obtained at discrete time intervals, encoded in a digital format such as pulse code modulation.

The term “communication unit” refers to a hardware and software combination configured to transmit and receive data between devices over a communication medium, including at least one of a wired interface and a wireless interface, and a communication protocol stack.

The term “speech recognition engine” refers to a software-implemented or hardware-implemented module configured to convert digital audio data representing speech into text data by performing acoustic analysis, pattern matching, and language modeling.

The term “text data” refers to a sequence of characters, symbols, or tokens that represent linguistic content in a human language, obtained by converting speech or other input data into a textual representation.

The term “natural language processing algorithm” refers to a computational procedure executed by a processor to analyze text data in a human language, including at least one of tokenization, part-of-speech tagging, syntactic parsing, semantic analysis, and named-entity recognition.

The term “keywords” refers to constituent textual elements within text data, such as words or tokens, that are determined to be important for identifying or characterizing an intent, a topic, or parameters of a user request.

The term “phrases” refers to groups of two or more related textual elements within text data, such as noun phrases or verb phrases, that together express a concept or relation relevant to an intent or parameters of a user request.

The term “intent recognition algorithm” refers to a computational procedure executed by a processor to infer a user's underlying purpose or goal, and associated parameters, from text data and extracted features such as keywords and phrases.

The term “intent information” refers to structured data representing a classification or label of a user's underlying purpose or goal in making an utterance, such as a type of requested operation or service.

The term “parameter information” refers to structured data representing one or more attributes, arguments, or slots associated with intent information, such as time, location, object, or other context values needed to fulfill the user's intent.

The term “external information source” refers to a data providing entity or service located outside a server, such as a remote database, a web service, or an application programming interface accessible over a communication network.

The term “internal information source” refers to a data storage or data providing component located within or directly associated with a server, such as a local database, a cache, or an in-memory data structure.

The term “related information” refers to data obtained from at least one of an external information source and an internal information source that is selected or generated in accordance with intent information and parameter information and is relevant for satisfying a user's request.

The term “optimal option” refers to at least one piece of information, recommendation, or selectable item determined by a processor, based on related information and intent information, as being most suitable for presentation to a user in view of a particular request.

The term “response content” refers to information prepared for presentation to a user, including at least one of text, structured data, and selection items, that is generated or selected in response to a user's utterance.

The term “meta information” refers to structured data that describes or summarizes other data related to a user request, including at least one of intent information, parameter information, keywords, phrases, and related information.

The term “prompt sentence” refers to a textual instruction or input sequence generated by a processor, based on meta information, and formatted to be supplied as input to a generative AI model to cause the generative AI model to generate a desired output.

The term “generative AI model” refers to a machine-learned model configured to generate data, including text, in response to an input prompt, by predicting subsequent tokens or structures using parameters learned from training data.

The term “natural language response sentence” refers to a sequence of words in a human language generated by a generative AI model or other processing, which is intended to be presented to a user as an answer or explanation corresponding to a user's request.

The term “user interface” refers to a combination of hardware and software components that enable a user to provide input to, and receive output from, a computing apparatus, including at least one of a display unit, a microphone, a speaker, and an input control.

The term “input device” refers to a hardware component configured to receive input from a user, such as a keyboard, a pointing device, a touch panel, or a gesture sensor.

The term “service providing apparatus” refers to a computing entity configured to provide a specific type of service or data, such as an information retrieval apparatus, a location information providing apparatus, a schedule management apparatus, or a transaction support apparatus.

The term “inquiry information” refers to structured data generated by a processor and transmitted to a service providing apparatus, specifying a request for information or processing needed to satisfy a user's intent.

In one embodiment, a server cooperates with at least one terminal operated by a user to implement the invention. The terminal includes a microphone, a speaker, a display, and a communication unit such as a wireless transceiver. The server includes at least one processor, a memory storing programs and data structures, and a network interface. The server may be realized by a physical computing apparatus or a virtual computing instance. The terminal may be realized by a mobile device, a desktop device, or an embedded device.

The user speaks toward the terminal. The terminal uses its microphone hardware and an audio driver provided by an operating system, for example an audio recording application programming interface, to convert the analog sound pressure of the user's speech into sampled digital audio data. The terminal performs sampling at a predetermined sampling rate, for example 16 kHz, and quantization at a predetermined bit depth, for example 16 bits per sample, to obtain a pulse-code-modulated audio stream. The terminal buffers this audio stream in a frame structure in memory, where each frame corresponds to a fixed time window, for example 20 milliseconds. The terminal may additionally apply digital signal processing operations such as noise suppression or automatic gain control, using an audio processing library, to reduce environmental noise and improve the signal-to-noise ratio of the speech signal.

The terminal transmits the digital audio data to the server through a communication network. The terminal encapsulates the audio frames in a data packet structure and sends the packets to the server by way of a communication protocol stack, for example an internet protocol stack over a wireless or wired medium. The server receives the packets via its network interface, reassembles the packets into a continuous audio stream, and stores the stream in a buffer in the memory.

The server converts the audio stream into text data by using a speech recognition engine. The server may use a software library or service conforming to a general-purpose speech recognition framework, such as a statistical model-based engine or a neural network-based engine. In one embodiment, the server uses an acoustic model implemented as a deep neural network, for example a convolutional-recurrent architecture or a transformer-based acoustic model, trained on a large corpus of labeled speech data. The server feeds each audio frame or a feature vector derived from the audio frame, such as a Mel-frequency cepstral coefficient vector, into the acoustic model. The acoustic model outputs probability distributions over phonetic units, which the server then decodes using a language model such as an n-gram model or a neural language model to obtain the most probable word sequence. The server thereby generates text data representing the user's utterance and stores the text data in a text buffer associated with a session identifier.

The server performs natural language processing on the text data. The server uses a natural language processing library, such as a rule-based tokenizer or a neural sequence tagger, to segment the text into tokens. The server applies part-of-speech tagging and syntactic parsing to the token sequence, for example by executing a recurrent neural network tagger or a transformer-based tagger that has been trained on a part-of-speech labeled corpus. The server also applies a dependency parser to derive syntactic relations between tokens. The server stores the results of this analysis in a structured representation, for example a data structure that associates each token with its part-of-speech tag, lemma, and dependency relation.

The server extracts keywords and phrases from the structured representation. The server selects tokens and groups of tokens that satisfy predetermined criteria, for example tokens that are tagged as nouns, verbs, or adjectives and phrases that correspond to noun phrases or verb phrases in the parsed dependency tree. The server may compute a score for each candidate token or phrase, for example a term frequency-inverse document frequency score or a domain-specific importance score, and filter out candidates whose scores are below a threshold. The server thus generates a keyword list and a phrase list for each utterance. The server stores these lists in a keyword buffer and a phrase buffer, together with the associated text data and session identifier.

The server recognizes the intent of the user by executing an intent recognition algorithm on the text data and on the extracted keywords and phrases. In one embodiment, the server uses a neural network classifier based on a transformer architecture. The server inputs a sequence of token embeddings into the transformer encoder, where each embedding encodes a token identity and position information. The server may also append feature vectors that encode the presence of the token in the keyword list or phrase list. The transformer layers compute contextualized representations by applying multi-head self-attention operations and feed-forward sublayers. A classification head then maps the representation of a special classification token to an intent label and associated parameter slots, such as time, location, or object type. The server computes a loss function, such as a cross-entropy loss, during training on a labeled dataset of utterances and intent labels, and updates network weights by a gradient-based optimization algorithm such as stochastic gradient descent with adaptive moments. In deployment, the server uses the trained weights to infer intent information and parameter information from new utterances without further weight updates.

In another embodiment, the server uses a rule-based intent recognition algorithm. The server executes a rule engine that contains rules specifying combinations of keywords and phrases and their mapping to intent labels and parameter structures. For example, a rule may specify that presence of a time-related keyword and a weather-related keyword implies an intent corresponding to a weather forecast query, and that the time-related keyword should be stored as a date parameter. The server may combine rule-based decisions and neural network outputs by computing a confidence score for each and selecting or merging results based on the scores.

The server uses the recognized intent information and parameter information to obtain related information from one or more information sources. The server uses an interface module to access an internal database or an external service. For example, the server may access a database that stores user preferences or a schedule, or may call a network-based information service, such as a location information provider or a weather data provider. The server converts the intent information and parameter information into a query structure, for example a key-value map where keys represent parameter types such as “date” or “location” and values represent parameter values. The server then generates an inquiry message formatted for the target information source, for example a structured query for a database, or a request message for a web-based application programming interface. The server transmits the inquiry, receives a response containing raw data, and parses the response into a standardized internal representation, such as a list of records with attribute fields.

The server determines at least one optimal option or response candidate from the related information. The server may rank multiple records based on predefined criteria, such as relevance scores derived from similarity measures between parameters and record attributes, or based on user preferences stored in the internal database. The server may also aggregate numerical values or perform computations, such as selecting a time range with the most favorable conditions. The server selects one or more records or computed results as candidates for presentation to the user and stores them in an option buffer.

The server generates a prompt sentence for a generative AI model based on meta information. The meta information includes the intent information, the parameter information, the keywords, the phrases, and at least a portion of the related information. The server constructs the prompt sentence according to a template or an algorithm that arranges these pieces of information into a textual instruction. For example, the server may generate a prompt sentence of the following form:
“The user utterance was: ‘Tell me tomorrow's weather.’ The recognized intent is a weather forecast query for tomorrow at the user's current location. The retrieved data indicate: clear sky, high 25 degrees Celsius, low 17 degrees Celsius, 10 percent chance of rain. Please generate a concise, user-friendly answer in English that explains tomorrow's weather to the user.”

The server supplies the prompt sentence to a generative AI model. In one embodiment, the generative AI model is a transformer-based language model that has been pre-trained on a large corpus of text data. The server encodes the prompt sentence into a sequence of token identifiers and provides the sequence as input to the generative AI model. The generative AI model processes the sequence through multiple attention layers and feed-forward layers to compute probability distributions over possible next tokens. The server repeatedly samples or selects the most probable next token according to a decoding strategy such as greedy decoding, beam search, or nucleus sampling, until a termination condition is satisfied. The server then decodes the generated token sequence into a natural language response sentence. Because the prompt sentence includes structured meta information derived by the earlier processing stages, the generative AI model can generate a response that is more accurate and contextually aligned with the user's actual desire than in a system that uses only raw text. The server transmits the generated response sentence or the selected optimal option to the terminal for presentation. The server encapsulates the response in a message that may include fields such as the response text, an intent label, and structured parameters. The terminal receives the message, parses the content, and uses a display unit to show the response text or uses a speaker and a text-to-speech engine to output synthesized audio corresponding to the response. The user views or listens to the response and may provide further speech input, thereby enabling iterative interaction.

This configuration yields technical effects beyond mere automation of human tasks. The server integrates speech recognition, natural language processing, intent recognition, information retrieval, and generative model prompt construction into a unified processing pipeline, where each intermediate representation is explicitly utilized to improve subsequent stages. Because the server generates the prompt sentence from meta information that has been computed and stored in specific data structures, the generative AI model receives an input that is less ambiguous and more informative than unstructured text alone. As a result, the server reduces the number of iterations required to obtain a satisfactory response, thereby reducing processing time and network traffic. The use of structured intent and parameter information also allows the server to cache partial results and reuse them across similar requests, further decreasing processing load.

From a computer-technology standpoint, the server improves accuracy and efficiency of natural language understanding by using a combination of feature extraction, deep learning-based intent classification, and rule-based refinement. The server can precompute and persist frequently used keyword patterns and phrase templates in an indexed data store, enabling faster matching and lowering latency. The server also reduces communication overhead by transmitting compressed audio and by transmitting only structured summaries and final responses rather than raw intermediate data between modules. The internal data structures, including buffers for audio frames, token-level annotations, keyword lists, phrase lists, intent records, and meta information, enable the processor to manage and access relevant information without repeating costly computations.

In one variation, the server uses a recurrent neural network architecture, such as a bidirectional long short-term memory network, instead of a transformer architecture for intent recognition. In another variation, the server uses a probabilistic graphical model or a support vector machine classifier for certain domains where data is sparse. In yet another variation, the server merges outputs of multiple models by using an ensemble method, such as weighted voting or stacking, to increase robustness. The server may also use data augmentation methods for training, such as paraphrase generation or noise injection in text, to improve generalization and decrease error rates on unseen utterances.

The server can also adjust the behavior of the generative AI model by varying parameters of the decoding algorithm, such as temperature or top-k values, based on intent type and user preferences stored in the internal database. For example, the server can set a lower temperature for queries requiring precise factual answers and a higher temperature for queries allowing more varied responses. Such dynamic adaptation leads to an improved balance between determinism and flexibility, which is difficult to achieve with manual rule-based systems.

The terminal benefits from reduced computational requirements, because heavy processing such as neural network inference and complex natural language parsing is performed on the server. The terminal mainly executes lightweight processing such as audio capture, data transmission, and presentation. This division of labor allows the system to support terminals with limited processing power while still achieving high-quality natural language understanding and generation.

Because the server uses its processor to transform raw acoustic signals into structured representations through multiple algorithmic stages, and because these stages are arranged and interconnected in a way that optimizes data reuse and reduces redundant computation, the invention improves the functioning of the computer system itself, rather than simply implementing a known human workflow on a generic computer. The specific configuration of data structures, models, and prompt construction rules causes a technical effect of reduced latency, improved accuracy of intent recognition, reduced error in generated responses, and more efficient use of network and computational resources.

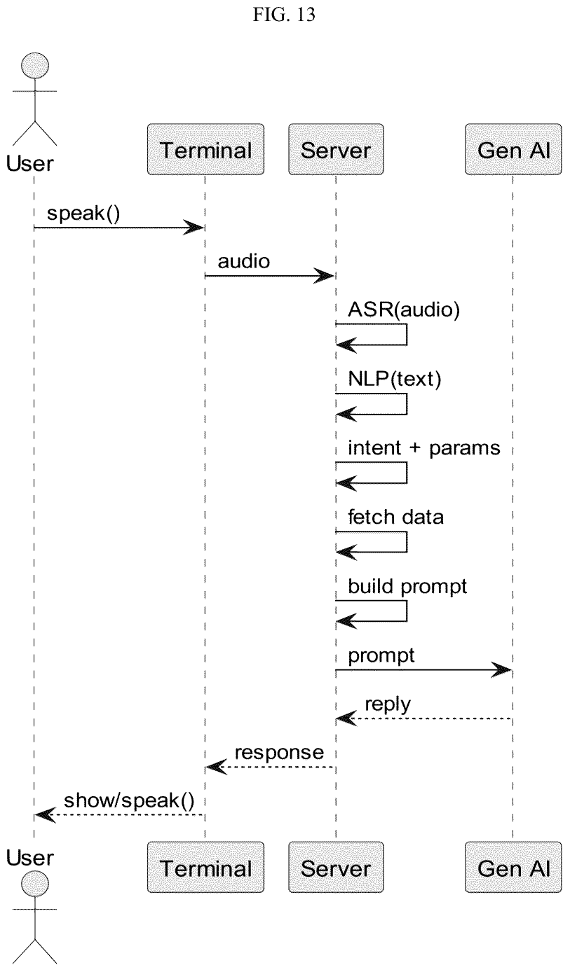

The following describes the processing flow using FIG. 13.

### Step 1

The user speaks toward the terminal.
The input is an analog acoustic signal corresponding to the user's utterance.
The terminal uses its microphone hardware and audio driver to capture the analog sound pressure over time and samples the signal at a fixed sampling rate (for example, 16 kHz) with a fixed bit depth (for example, 16 bits). The terminal converts the sampled values into digital audio frames, each frame corresponding to a short time window (for example, 20 ms). The terminal may perform data processing such as noise reduction and automatic gain control on each frame by applying digital filters and gain adjustment algorithms. The output is a sequence of noise-reduced digital audio frames held in the terminal's memory.

### Step 2

The terminal transmits the digital audio frames to the server.
The input is the sequence of digital audio frames stored in the terminal's buffer.
The terminal groups the frames into packets, adds headers including sequence numbers and format information, and passes the packets to a communication stack. The terminal uses a transport protocol to send the packets through a network interface to a designated server address. The server receives the packets, verifies integrity by checking sequence numbers and checksums, and reassembles the frames into a continuous digital audio stream. The output at the server side is a buffered digital audio stream associated with a session identifier.

### Step 3

The server performs speech recognition to convert the audio stream into text data.
The input is the buffered digital audio stream for the session.
The server computes acoustic features such as Mel-frequency cepstral coefficients for each frame by applying a Fourier transform and filter bank analysis. The server feeds the feature vectors into an acoustic model implemented as a neural network, which outputs probability distributions over phonetic units or characters for each time step. The server then applies a decoding algorithm, such as beam search with a language model, to compute the most probable sequence of words. The output is a text string representing the user's utterance, stored as text data in the server's memory.

### Step 4

The server performs text preprocessing and tokenization.
The input is the text string output from speech recognition.
The server normalizes the text by applying operations such as lowercasing, whitespace normalization, and removal of control characters. The server uses a tokenizer from a natural language processing library to split the normalized text into tokens (words, punctuation, or subword units). The server records the token sequence and assigns indices to each token for downstream processing. The output is a tokenized representation of the utterance, including the ordered list of tokens and their positions.

### Step 5

The server performs linguistic analysis on the tokenized text.
The input is the ordered list of tokens produced in Step 4.
The server applies a part-of-speech tagging model, such as a recurrent or transformer-based sequence tagger, to assign a grammatical category (for example, noun, verb, adjective) to each token. The server then runs a syntactic parser, such as a dependency parser, to compute syntactic relations between tokens, such as subject-verb and modifier-head relations. The output is a structured linguistic representation that includes, for each token, its part-of-speech tag and its syntactic relation to other tokens.

### Step 6

The server extracts keywords and phrases from the linguistic representation.
The input is the structured linguistic representation including tokens, tags, and syntactic relations.
The server selects candidate tokens whose part-of-speech tags match predetermined categories (for example, nouns and verbs) and groups certain tokens into phrases based on syntactic patterns (for example, head noun plus modifiers). The server calculates importance scores for candidates using metrics such as term frequency-inverse document frequency or rule-based weights. The server filters out low-scoring candidates and compiles a keyword list and a phrase list. The output is a set of extracted keywords and phrases stored in association with the original text.

### Step 7

The server recognizes the user's intent and parameters.
The input is the tokenized text, the keyword list, and the phrase list.
The server encodes the token sequence into embeddings and augments the embeddings with features indicating whether a token belongs to the keyword list or a phrase. The server forwards the enriched sequence into an intent recognition model, such as a transformer-based classifier, which computes contextual representations via self-attention and feed-forward operations. A classification layer maps the aggregated representation to an intent label and extracts slot values representing parameters such as date, time, or location. Optionally, the server applies rule-based post-processing to adjust or refine the label and parameters. The output is structured intent information (intent label) and parameter information (slot values) stored in an intent record.

### Step 8

The server retrieves related information from information sources.
The input is the intent information and parameter information.
The server constructs a query object that maps parameter names to parameter values (for example, “date: tomorrow,” “location: current location”). The server determines which internal database or external service is relevant for the intent label, such as a schedule database or a weather information service. The server formats the query object into a database query or a service request message and sends it through an appropriate interface. The server receives the response, parses response fields, and converts them into a uniform internal data structure, such as a list of records with key-value attributes. The output is related information, normalized for internal use.

### Step 9

The server determines optimal options or response candidates from the related information.
The input is the set of records or data items obtained as related information.
The server evaluates each record against a scoring function that may consider relevance to the parameters, historical user preferences, or domain-specific rules. The server may compute similarity scores using vector representations of attributes or apply ranking rules that prioritize certain conditions (for example, earliest time or highest rating). The server selects one or more records with the highest scores and may aggregate or summarize their attributes, such as computing an average or selecting representative values. The output is a set of one or more optimal options or response candidates.

### Step 10

The server generates a prompt sentence for a generative AI model.
The input is the intent information, parameter information, keywords, phrases, and the selected options or response candidates.
The server assembles these elements into a meta-information structure and maps the structure into a natural language instruction according to a predetermined template. For example, the server concatenates a description of the user's utterance, a description of the recognized intent and parameters, and a textual summary of the related information. The server may generate a prompt sentence such as:
“The user utterance was: ‘Tell me tomorrow's weather.’ The recognized intent is a weather forecast query for tomorrow at the user's current location. The retrieved data indicate: clear sky, high 25 degrees Celsius, low 17 degrees Celsius, 10 percent chance of rain. Please generate a concise, user-friendly answer in English that explains tomorrow's weather to the user.”
The output is a complete prompt sentence stored as a text string ready for input to the generative AI model.

### Step 11

The server generates a natural language response using the generative AI model.
The input is the prompt sentence created in Step 10.
The server tokenizes the prompt sentence into subword units and feeds the token sequence into a generative language model, such as a multi-layer transformer decoder. The model computes probability distributions over possible next tokens for each decoding step using attention mechanisms and learned weight matrices. The server applies a decoding strategy, for example greedy search or beam search, to iteratively select the next token based on the probability distribution and appends it to the output sequence until an end-of-sentence token is generated or a length limit is reached. The server then detokenizes the output sequence into a human-readable text string. The output is a natural language response sentence that reflects both the user's intent and the related information.

### Step 12

The server transmits the response to the terminal and the terminal outputs the response to the user.
The input at the server side is the response sentence and, optionally, the optimal options.
The server constructs a response message that contains at least the response sentence and may include structured fields representing options and parameters. The server sends the message to the terminal via the network interface. The terminal receives the message, parses the response sentence, and stores it temporarily. The terminal then uses its display to render the response sentence as text and may invoke a text-to-speech engine to synthesize audio and play the audio through the speaker. The output is a visual and/or auditory presentation of the response to the user, completing one interaction cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional voice-based interfaces generally convert user speech into text and apply simple rule-based or intent-classification logic to trigger predefined actions. Such systems often ignore nuanced aspects of user input, including emotional state, contextual preferences, current location, and rich sets of candidate options stored in heterogeneous data collections. As a result, known systems tend to output rigid, generic responses that are weakly personalized and frequently misaligned with the user's underlying desire. From a computing perspective, this leads to suboptimal utilization of available data resources and processing capabilities, fragmented processing pipelines, and inefficient interaction loops between the user and the system.

Furthermore, in many existing architectures, the speech recognition component, the natural language processing component, any form of recommendation engine, and any generative artificial intelligence model are loosely coupled, if present at all. There is no unified mechanism to transform intermediate computational artifacts-such as extracted keywords, inferred intent, emotion estimates, and candidate records from databases-into a structured prompt that systematically steers a generative model. Without such a mechanism, the system cannot reliably leverage generative artificial intelligence as a computational module to improve ranking, explanation, and presentation of options.

Additionally, known systems do not provide a robust, processor-level method to combine real-time emotion analysis of user input with context information (such as user attributes, current position information, and past history information) and large-scale stored candidate information, and then feed this combined information into a generative artificial intelligence model in a reproducible manner. This results in increased processing latency due to ad hoc calls to multiple services, inconsistent response quality, and difficulty in scaling or maintaining the overall system behavior as data volumes and model complexities grow.

In particular, there is a need for an improved computer-implemented technique that: (i) acquires user voice input and converts it into machine-usable representations; (ii) performs integrated natural language and emotion analysis to generate structured intent information and emotion information; (iii) efficiently searches and evaluates candidate information in one or more storage units; and (iv) constructs a well-defined prompt sentence that encapsulates these computational results and context information, to be supplied to a generative artificial intelligence model. Such a technique should enable the processor to determine, with reduced computational overhead and improved consistency, an optimal option to be presented to the user, thereby enhancing both system efficiency and the quality of human-computer interaction.

The specific processing by the specific processing unit 290 of the data processing device 12 in Application Example 2 is realized by the following means.

The present invention provides a server comprising a processor, the processor being configured to acquire voice input of a user and convert the voice input into a digital signal; to transmit the digital signal to a speech recognition processing unit to obtain character string data representing the voice input; to apply natural language processing to the character string data to extract words and phrases and generate intent information indicating a desire of the user; to execute emotion analysis processing on at least one of the voice input and the character string data to generate emotion information indicating an emotional state of the user; to search candidate information stored in at least one information storage unit based on the intent information and the emotion information, evaluate the candidate information, and generate a candidate set; to generate a prompt sentence including at least the candidate set, the intent information, the emotion information, and user attribute information, and to input the prompt sentence to a generative artificial intelligence model to cause the generative artificial intelligence model to generate recommendation information expressed in natural language; and to determine an optimal option to be presented to the user based on the recommendation information and the candidate set, and to generate output data representing the optimal option. This enables an integrated computing pipeline in which the server systematically transforms multimodal user input into structured intent and emotion data, efficiently searches and scores large-scale candidate information, and leverages a generative artificial intelligence model through a processor-constructed prompt sentence, thereby improving the technical performance of the recommendation process in terms of accuracy, consistency, resource utilization, and latency, and resulting in more contextually appropriate and personalized options presented to the user.

The term “voice input” refers to an acoustic signal produced by a user and captured by an input transducer such as a microphone for subsequent processing by an electronic computing system.

The term “digital signal” refers to a time-discrete, quantized representation of an analog voice signal that is generated by conversion circuitry and is processable by a digital processor.

The term “speech recognition processing unit” refers to a hardware circuit, software module, or combination thereof configured to receive a digital signal representing speech and output character string data corresponding to recognized linguistic content.

The term “character string data” refers to a sequence of encoded characters representing a transcription of user speech, suitable for processing by natural language processing algorithms.

The term “natural language processing” refers to a set of computational procedures applied to character string data to analyze linguistic structure, including at least one of tokenization, part-of-speech tagging, syntactic parsing, semantic analysis, and phrase extraction.

The term “words and phrases” refers to lexical units and multi-word expressions identified within character string data as discrete linguistic elements relevant to understanding user intent.

The term “intent information” refers to structured data representing an inferred purpose, desire, or requested action of a user, derived from analysis of character string data.

The term “emotion analysis processing” refers to computational operations that estimate an emotional state of a user based on at least one of acoustic features of voice input and semantic features of character string data.

The term “emotion information” refers to structured data representing an estimated emotional state of a user, including at least one of categorical emotion labels and numerical scores associated with emotional dimensions.

The term “information storage unit” refers to an electronic storage resource, such as a memory device or database system, configured to store candidate information and other data accessible by a processor.

The term “candidate information” refers to data records representing items, entities, services, or options that are potentially selectable for presentation to a user.

The term “candidate set” refers to a subset of candidate information obtained by searching and evaluating stored records in view of intent information and emotion information.

The term “user attribute information” refers to data that characterizes a user, including at least one of demographic attributes, preference records, historical usage data, and current context information.

The term “prompt sentence” refers to a machine-generated textual input, including natural language text and optionally structured metadata, constructed to instruct a generative artificial intelligence model to produce recommendation information.

The term “generative artificial intelligence model” refers to a trained computational model configured to generate natural language output in response to an input prompt sentence based on learned statistical relationships.

The term “recommendation information” refers to natural language data generated by a generative artificial intelligence model that describes, ranks, or explains one or more options suitable for a user.

The term “optimal option” refers to at least one element selected from the candidate set based on evaluation criteria including recommendation information, intent information, emotion information, and user attribute information.

The term “output data” refers to digital information generated by the processor that encodes the optimal option and is suitable for transmission to and presentation by an output device.

The term “utterance content” refers to linguistic information corresponding to what the user has expressed verbally, as represented in character string data.

The term “response style specification information” refers to data indicating one or more desired characteristics of a system response, including at least one of tone, level of detail, language, and formatting.

The term “product information” refers to candidate information describing tangible or intangible goods, including attributes such as name, category, price, and specification.

The term “facility information” refers to candidate information describing physical locations or establishments, including attributes such as type, address, and available services.

The term “route information” refers to candidate information describing paths or travel plans between locations, including attributes such as waypoints, estimated time, and distance.

The term “information service information” refers to candidate information describing services that provide data or content to a user, including attributes such as service type, access method, and usage conditions.

The term “current position information” refers to data indicating a geographic location associated with a user or a user device at a given time, expressed in at least one of coordinates and region identifiers.

The term “past history information” refers to data representing previous interactions, selections, or behaviors of a user, recorded for use in subsequent processing.

The term “processor” refers to one or more hardware processing elements, such as central processing units, graphics processing units, or dedicated accelerators, configured to execute instructions and perform the operations described herein.

In an embodiment, server, terminal, and user cooperate to implement the invention. Server includes at least one processor, a main memory, a nonvolatile storage device, a network interface, and access to an information storage unit such as a database system. Server may be implemented on a general-purpose computing platform, for example a rack-mounted computer with one or more central processing units and optionally one or more graphics processing units. Server executes software components including a speech recognition client, a natural language processing engine, an emotion analysis engine, a recommendation engine, and an interface module to a generative AI model.

Terminal includes at least one processor, a memory, a microphone, an audio codec including an analog-to-digital converter, a display, a loudspeaker, and a communication interface such as a wireless transceiver. Terminal may be implemented as a mobile computing device, such as a smartphone, a tablet, smart glasses, or an in-vehicle infotainment unit. Terminal executes an application that captures voice input from user, encodes audio data, communicates with server over a communication network, and presents output data to user.

User interacts with the system using voice, without being required to operate a keyboard or pointing device. User issues a request in natural language, listens to or reads the response provided by terminal, and may optionally provide feedback or a selection.

Server executes a program that is stored in the nonvolatile storage device. The program defines a pipeline of data structures and algorithms. Audio data from user is represented as an array of digital samples, for example 16-bit linear pulse-code modulation data at a sampling rate of 16 kHz. Character string data is represented as a sequence of encoded characters, for example UTF-8 encoded text. Intent information, emotion information, user attribute information, and candidate information are represented as structured records, for example as key-value maps and typed fields internally in memory. A prompt sentence is represented as a text buffer that concatenates natural language text with formatted lists of candidate items and associated attributes.

Server uses a speech recognition engine to convert the digital samples into character string data. The speech recognition engine may be implemented locally on server or accessed as a network service executing on separate computing equipment. The engine uses acoustic models and language models that may include recurrent neural networks or transformer-based architectures. The acoustic model receives acoustic feature vectors computed from the digital signal, for example Mel-frequency cepstral coefficients or log-Mel filterbank energies, and outputs probabilities over phonetic units. The language model receives sequences of tokens and outputs probabilities over likely next tokens. Server sends the digital signal to the speech recognition engine and receives the most likely transcription as character string data. Server applies natural language processing to the character string data using software such as a tokenization module, a part-of-speech tagger, a dependency parser, and a named-entity recognizer. These components may be implemented using statistical models or neural network models, such as transformer-based encoders. Server converts the text into a sequence of tokens, each token including a surface form, a lemma, a part-of-speech tag, and a position index. Server then constructs a dependency graph where nodes correspond to tokens and edges correspond to syntactic relations. From this representation, server identifies words and phrases that are salient for the task, such as head nouns, direct objects, and verb-object combinations. Server thereby generates intent information as a compact data structure, for example:
an intent type field that can take values such as “purchase-request,” “restaurant-search,” “tourist-spot-search,” “information-request,” or “relaxation-request”;
a target field that stores tokens or phrases describing an object, such as “smartphone,” “spicy curry,” or “seaside place”;
an attribute list that stores adjectives, adverbs, or other modifiers, such as “new,” “nearby,” “within 2 hours,” or “medium spicy.”

Server performs emotion analysis processing using an emotion analysis engine. In one embodiment, the emotion analysis engine is implemented as a neural network classifier that processes acoustic features and/or textual features. For acoustic features, server computes frame-level feature vectors such as pitch, energy, spectral coefficients, and voice quality indicators. These features are input into a neural network model, for example a convolutional neural network followed by a recurrent layer and fully connected classification layers. For textual features, server encodes the character string data using an embedding module, for example a transformer encoder that maps each token into a vector representation. Server then pools token embeddings and passes them through one or more dense layers to output emotion scores. Emotion information may include probabilities or scores for predefined emotion categories such as “joy,” “stress,” “sadness,” “anger,” or “calmness,” and continuous values for dimensions such as arousal and valence. Server stores these values in memory as fields of the emotion information structure.

Server uses an information storage unit to store candidate information. The information storage unit may be implemented as a relational database system, a key-value store, or a document-oriented store residing on one or more storage devices. Candidate information records may include product information (for example attributes such as category, price, specification, rating), facility information (for example attributes such as address, type, opening hours, tags), route information (for example attributes such as origin, destination, estimated time, distance), and information service information (for example attributes such as service name, access endpoint, usage constraints).

Server uses a recommendation engine that executes on the processor to search the information storage unit using intent information and emotion information as query constraints. In an embodiment, server constructs structured queries based on the intent type and target. For example, when intent type is “purchase-request” and target is “smartphone,” server constructs a query against a product table filtered by a “category” column equal to “smartphone” and optionally by attributes such as price range or camera performance derived from user attribute information. When intent type is “restaurant-search” and target is “spicy curry,” server constructs a query against a restaurant table filtered by cuisine, spiciness-level tags, and geographic distance derived from current position information.

Server calculates a score for each candidate record returned by the query. The score may be a weighted sum of sub-scores, such as a relevance sub-score based on keyword matching, a distance sub-score based on geographic distance, a preference sub-score based on similarity to past history information, and an emotion sub-score reflecting how well the candidate aligns with the detected emotion. For example, when emotion information indicates stress and intent information indicates “relaxation-request,” server may increase the scores of candidates tagged with “quiet,” “park,” or “spa” tags. The scoring algorithm is implemented as a deterministic computation on numerical fields, and parameters such as weights may be stored in configuration data or learned offline by a training procedure.

Server generates a candidate set by selecting the top-ranked candidate records according to the calculated scores. Each candidate record in the candidate set includes identifiers, names, descriptive attributes, and one or more numeric scores. Server stores this candidate set as an array or list in memory.

Server generates a prompt sentence to be provided to a generative AI model. In an embodiment, the generative AI model is a neural network language model based on a transformer architecture. The model has multiple attention layers, each layer storing sets of weight matrices representing query, key, and value projections. The model has been trained on large corpora of text to minimize a cross-entropy loss between predicted tokens and observed tokens, using gradient-based optimization with backpropagation and a chosen optimizer such as Adam. During inference, server provides an input sequence of tokens representing the prompt sentence, and the model generates a sequence of output tokens representing recommendation information. The generative AI model may be hosted as a separate service or integrated into server.

Server constructs the prompt sentence using a non-conventional data fusion method. Specifically, server concatenates natural language segments and structured descriptions of the candidate set, intent information, emotion information, and user attribute information into a single textual prompt. The prompt sentence may explicitly identify the user utterance, paraphrased intent, emotion category, and candidate list with attributes. For example, server may construct a prompt sentence as follows:
“User utterance: ‘I want a new smartphone.’
Recognized intent: buy a new smartphone.
User preferences: high-quality camera, budget around 800.

### Candidate Models:

1. Model A—price 750—excellent camera—large battery.
2. Model B—price 820—very good camera—compact size.
3. Model C—price 650—good camera—budget-friendly.
User emotion: neutral and relaxed.
As a recommendation assistant, select the best 2 models and explain briefly in English why they match the user's needs. Be concise and user-friendly.”
In another example, server may construct a prompt sentence for a seaside tourist spot search:
“User utterance: ‘I want to see the sea.’
Intent: visit a seaside tourist spot near the user's current location (near a large city).

### Candidate Spots With Travel Time by Train:

1. Seaside Area X—about 70 minutes—wide beach—many cafés.
2. Island Y—about 80 minutes—island with lighthouse—sea views.
User emotion: joyful and excited.
Recommend one or more spots and describe why they are enjoyable for someone who wants a relaxing seaside trip.”
In another example for a restaurant search, server may construct:
“User utterance: ‘I want to eat spicy curry today.’
Intent: eat spicy curry near current location.
User history: prefers a certain cuisine, medium-high spiciness.

### Candidate Restaurants Within 3 km:

1. Restaurant X—very spicy—rating 4.5.
2. Restaurant Y—medium spicy—rating 4.3.
3. Restaurant Z—medium-high spicy—rating 4.6.
User emotion: positive and excited.
Recommend the top choices and propose a friendly promotional message if appropriate.”

By constructing prompt sentences in this way, server causes the generative AI model to perform a complex optimization over explanations and rankings that would be difficult to encode solely through deterministic rules. The prompt sentence is not a simple restatement of the user's request; it is a machine-constructed synthesis of multiple internal data structures, including intent information, emotion information, user attribute information, and candidate scores. This synthesis exploits the generative AI model's learned representation space to reorder, filter, and verbally contextualize candidates, thereby improving the clarity and usefulness of the final response.

Server uses a specialized module to generate the prompt sentence. This module receives as input the intent information, emotion information, user attribute information, and candidate set, and outputs a text string. The module may implement rule-based template selection depending on intent type, and within each template, apply variable insertion and selective omission rules. For example, if emotion information indicates high stress, the template may include phrases such as “gentle, relaxing options” and may limit the number of candidates to avoid overwhelming user. If emotion information indicates joy, the template may use more enthusiastic wording and present more alternatives.

Server sends the prompt sentence to the generative AI model and receives recommendation information. The model internally executes attention-weighted matrix multiplications on token embeddings, layer by layer, to compute probability distributions over output tokens. To generate the text, the model repeatedly samples or chooses the highest-probability token, appends it to the output sequence, and updates its internal hidden state. Server controls parameters such as temperature, top-k or top-p sampling thresholds, and maximum token length to balance diversity and determinism of the response.

Server determines the optimal option based on both the recommendation information and the candidate set. In one embodiment, server parses the recommendation information to detect references to candidate identifiers or names. Server may use string matching, token similarity, or embedding-based similarity to map text segments back to candidate records. Server then updates scores of candidates according to the presence or emphasis in the recommendation information, for example boosting candidates explicitly recommended multiple times. Server selects one or more candidates whose combined score is maximal as the optimal option. Server then generates output data that includes identifiers and attributes of these candidates, as well as the recommendation information to be presented to user.

Terminal receives the output data via the communication interface and presents the information using the display and/or loudspeaker. Terminal renders text, images, and navigation controls; terminal may call a text-to-speech engine running locally to convert the recommendation information into audio, applying prosody patterns that are adjusted to emotion information. For example, if emotion information indicates stress, terminal may use a slower and softer voice; if emotion information indicates excitement, terminal may use a faster and more energetic voice.

This system provides technical improvements beyond merely automating human decision-making. Server uses the combination of intent information, emotion information, and candidate set to construct a prompt sentence in a non-conventional way that optimizes data flow between modules. By encoding structured data into the prompt sentence with explicit constraints and context, server reduces the amount of network traffic and number of API calls required to coordinate multiple separate services. For example, instead of performing multiple iterative requests between a rule-based recommender and a language generator, server performs a single call to the generative AI model with a complete context, thereby reducing communication latency and processing overhead.

Additionally, server achieves improved recommendation precision and consistency. Because intent information and emotion information are computed from dedicated models with clearly defined features and architectures, and because candidate scoring uses quantitative metrics and stored parameters, the selection of candidate set is deterministic and reproducible. The generative AI model then operates within the constrained space defined by this candidate set. This two-stage design reduces the search space for the generative AI model, thereby reducing the probability of irrelevant or hallucinated options and improving computational efficiency. The neural network models used in the speech recognition engine, the emotion analysis engine, and the generative AI model are trained using explicit procedures. Training data is prepared by collecting speech signals, textual transcriptions, labels for intents and emotions, and user interaction logs. For speech recognition, server (or a training environment) uses a loss function such as cross-entropy over phoneme or character sequences, and uses gradient descent to update model weights. For emotion analysis, server uses labeled data with target emotion categories and optimizes a classification loss. For the generative AI model, server uses a sequence-to-sequence or language modeling objective with cross-entropy loss and may apply data augmentation techniques such as synonym replacement or paraphrase generation to improve robustness. The architectures use multiple layers, attention mechanisms, and residual connections to provide high representational capacity without excessive inference time when deployed on optimized compute hardware.

Server can be configured in multiple variations. In one variation, speech recognition is performed locally on terminal, and terminal sends character string data instead of digital audio to server. In another variation, intent classification and emotion classification are implemented as separate models, and only the classification outputs are used to construct the prompt sentence. In yet another variation, the information storage unit is distributed across multiple servers, and candidate information is retrieved via federated queries. Despite these variations, the core concept remains: server constructs a prompt sentence that fuses intent information, emotion information, user attribute information, and a candidate set, and uses this prompt sentence as an interface to a generative AI model to generate recommendation information, which is then used to determine an optimal option.

Server thereby improves computer technology itself by providing a specific, structured integration of multiple models and data sources, optimizing data structures and information flow to achieve lower latency, reduced error rates in recommendation, improved use of network resources, and more effective internal management of large candidate datasets. The interaction pattern between terminal and server, and the internal operation of server, are defined in terms of concrete hardware components, data representations, and algorithmic modules, such that one skilled in the art can implement the invention without undue experimentation.

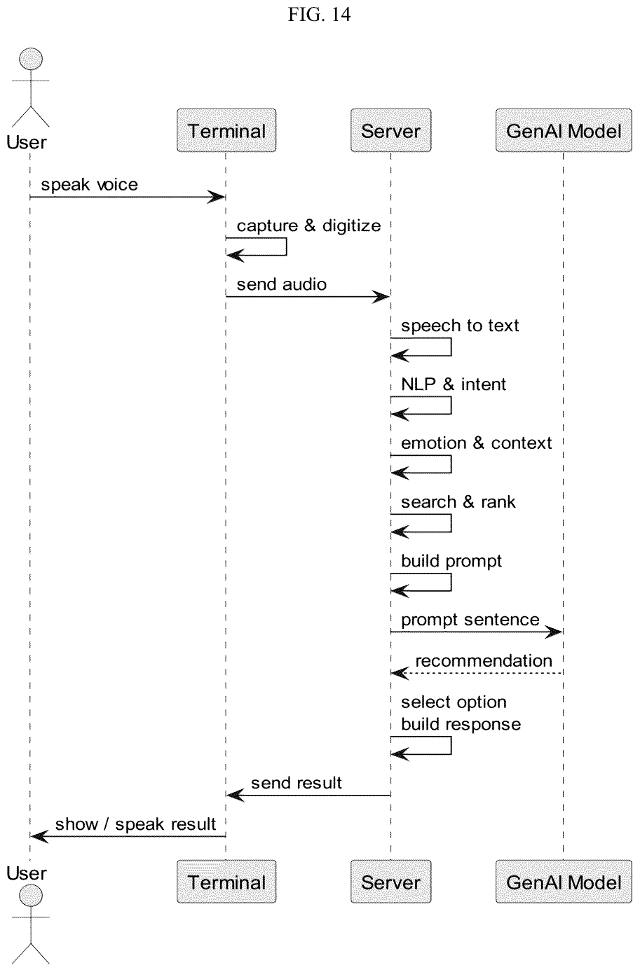

The following describes the processing flow using FIG. 14.

### Step 1

User provides a voice request to the system.
User speaks a natural-language utterance, such as “I want a new smartphone,” “I want to see the sea,” or “I want to eat spicy curry today,” toward the microphone of terminal.
Input: no digital input; the input is the user's acoustic voice.
Output: acoustic pressure waves incident on the terminal microphone.
User produces the acoustic voice signal that will be captured and converted by terminal in the subsequent step.

### Step 2

Terminal acquires and digitizes the voice input.
Terminal uses its microphone and audio codec to sample the analog voice signal and convert it to digital samples, for example 16-bit PCM at 16 kHz. Terminal stores the samples in an audio buffer in memory.
Input: analog audio signal from user.
Output: digital audio data buffer (array of samples).
Terminal applies anti-alias filtering, sampling, and quantization to transform the continuous-time, continuous-amplitude signal into a discrete-time, discrete-amplitude representation suitable for digital processing.

### Step 3

Terminal transmits the digital audio to server.
Terminal encapsulates the digital audio buffer into a network message (for example, an HTTP request body) and adds metadata such as language code and session identifier. Terminal sends this message through its network interface over a wired or wireless network to server.
Input: digital audio buffer and session metadata.
Output: network packet stream carrying the audio data to server.
Terminal performs packetization and optional compression (for example, encoding into a compressed audio format) to reduce size, then uses a transport protocol to deliver the data reliably to server.

### Step 4

Server receives the digital audio and invokes the speech recognition processing unit.
Server reads the incoming packets via the network interface, reconstructs the digital audio buffer, and stores it in main memory. Server calls a speech recognition engine, passing a pointer or reference to the audio buffer and recognition parameters.
Input: digital audio buffer and recognition parameters (for example, language, sampling rate).
Output: character string data representing a transcription of the audio.
Server performs pre-processing operations such as normalization of audio level and framing of the signal into short overlapping windows. The speech recognition engine computes acoustic features (for example, Mel-frequency cepstral coefficients), feeds them into an acoustic model (for example, a neural network), combines model outputs with a language model, and decodes the most probable sequence of words, returning the character string data to server.

### Step 5

Server performs natural language processing on the character string data.
Server passes the character string data to an NLP module that executes tokenization, part-of-speech tagging, syntactic parsing, and phrase extraction.
Input: character string data (for example, “I want a new smartphone”).
Output: a structured NLP representation containing tokens, tags, dependency relations, and extracted phrases.
Server splits the text into tokens, assigns each token a part-of-speech tag, builds a dependency tree, and applies rules or statistical methods to extract key phrases, such as “new smartphone,” “see the sea,” or “spicy curry.” This produces an internal data structure such as a list of tokens and a list of salient phrases.

### Step 6

Server generates intent information from the NLP representation.
Server analyzes the extracted tokens and phrases using an intent-classification algorithm, which may be a machine-learned classifier based on a neural network or other model.
Input: structured NLP representation (tokens, phrases, syntactic relations).
Output: intent information including an intent type, a target, and attribute data.
Server encodes the tokens and phrases into feature vectors (for example, using word embeddings), feeds them into the classifier, and receives an intent label (for example, “purchase-request,” “restaurant-search,” or “tourist-spot-search”) along with associated confidence values. Server sets an intent type field to the predicted label, a target field to the main object noun (such as “smartphone,” “sea,” or “curry”), and an attribute list to modifiers (such as “new,” “spicy,” or “nearby”). This processing transforms unstructured language content into a compact, machine-usable description of the user's desire.

### Step 7

Server performs emotion analysis to produce emotion information.
Server calls an emotion analysis engine, which may operate on acoustic features, textual features, or both, to estimate the user's emotional state.
Input: digital audio buffer and/or character string data.
Output: emotion information, such as scores for emotion categories and dimensions.
Server computes acoustic features like pitch, energy, and spectral measures, and/or embeds the text into vectors using a language model. Server feeds these features to an emotion classifier (for example, a neural network with fully connected layers), which outputs probabilities for emotions (for example, joy, stress, calmness). Server stores these probabilities in an emotion information structure, enabling downstream modules to adjust option selection accordingly.

### Step 8

Server acquires context including user attribute information and current position information.
Server receives current position information from terminal or from a location service, and retrieves user attribute information and past history information from an information storage unit.
Input: user identifier, session identifier, and optional position report from terminal.
Output: a context object containing user attributes, current position, and past history.
Server queries databases for stored preferences (for example, favorite brands, typical price ranges, preferred cuisine types) and logs of previous interactions (for example, selected restaurants, visited locations). Server then combines these data with current position coordinates (for example, latitude and longitude) into a context object stored in memory.

### Step 9

Server searches candidate information to build a candidate set.
Server uses intent information, emotion information, and the context object to query the information storage unit for candidate information corresponding to products, facilities, routes, or services.
Input: intent information (intent type, target, attributes), emotion information, and context object.
Output: a candidate set represented as a list of candidate records with attributes and scores initialized.
Server constructs one or more queries (for example, SQL statements or index lookups) filtering by category (such as “smartphone,” “restaurant,” “seaside spot”), by attribute tags (such as “spicy,” “quiet,” “new”), and by distance thresholds based on current position. Server executes the queries, obtains matching records, and initializes each candidate record with attributes such as name, description, price, location, and base relevance scores.

### Step 10

Server evaluates and ranks candidates according to quantitative criteria.
Server computes a composite score for each candidate using intent-related relevance, distance, preference matching, and emotion alignment.
Input: raw candidate records from the information storage unit and the context object.
Output: a ranked candidate set with updated scores and ordering.
Server calculates numerical sub-scores, such as: a similarity score between candidate attributes and target terms; a distance score based on geographic distance from current position; a preference match score based on matches to user history; and an emotion match score based on how well a candidate suits the emotion (for example, “quiet park” when stress is high). Server combines these sub-scores using a weighted function, stores the composite score in each candidate record, and sorts the list in descending order of score to produce the ranked candidate set.

### Step 11

Server selects top candidates and prepares data for a prompt sentence.
Server truncates the ranked candidate set to a limited number of top candidates and extracts key attributes to be inserted into the prompt sentence.
Input: ranked candidate set.
Output: a top-N candidate subset and a summary of their key attributes.
Server extracts for each top candidate a restricted set of attributes such as name, category, primary features, price, rating, and distance. Server encodes these fields into short textual descriptions (for example, “Model A—price 750—excellent camera—large battery”) that will be included in the prompt sentence.

### Step 12

Server constructs a prompt sentence for the generative AI model.
Server synthesizes a text that includes user utterance, intent information, emotion information, user attribute information, and the top candidate descriptions.
Input: intent information, emotion information, context object, and top-N candidate subset.
Output: a prompt sentence as a single text string.
Server selects a template according to intent type and fills template slots with relevant fields.
For example, for a product recommendation, server constructs:
“User utterance: ‘I want a new smartphone.’
Recognized intent: buy a new smartphone.
User preferences: high-quality camera, budget around 800.

### Candidate Models:

1. Model A—price 750—excellent camera—large battery.
2. Model B—price 820—very good camera—compact size.
3. Model C—price 650—good camera—budget-friendly.
User emotion: neutral and relaxed.
As a recommendation assistant, select the best 2 models and explain briefly in English why they match the user's needs. Be concise and user-friendly.”
Server builds this text by concatenating fixed phrases with variable parts obtained from the internal data structures, generating a coherent input string formatted for the generative AI model.

### Step 13

Server submits the prompt sentence to the generative AI model and receives recommendation information.
Server encodes the prompt sentence into tokens, forwards them to the generative AI model, and invokes inference to generate a natural-language response.
Input: prompt sentence text.
Output: recommendation information in natural-language text.
Server uses a client library to send the prompt to the model endpoint, controlling parameters such as maximum output length and sampling strategy. The generative AI model processes the tokens through multiple transformer layers, computes attention-weighted hidden states, and outputs a sequence of tokens for the recommendation text. Server decodes the tokens into a character string and stores this as recommendation information, which may, for example, identify particular candidates and provide explanatory sentences.

### Step 14

Server maps the recommendation information back to candidate records and determines the optimal option.
Server analyzes the recommendation text to detect explicit references to candidate names or features and updates candidate scores accordingly.
Input: recommendation information and the top-N candidate subset.
Output: one or more optimal options selected from the candidate subset.
Server may tokenize the recommendation text and compare tokens or phrases to candidate names and key attributes. For each match, server increments that candidate's score or flags it as recommended. Server then selects the candidate or candidates with the highest updated scores as optimal options. This processing integrates the generative model's qualitative judgment with the earlier quantitative scoring.

### Step 15

Server generates output data for presentation by terminal.
Server packages the optimal options and the recommendation information into a structured response payload.
Input: optimal options and recommendation information.
Output: output data including option identifiers, attributes, and explanation text.
Server creates a data structure that contains, for each optimal option, fields such as name, description, price or other attributes, and includes the recommendation text as a message. Server serializes this structure (for example, into a structured message format) and sends it to terminal via the network interface.

### Step 16

Terminal receives the output data and prepares a user interface.
Terminal parses the received payload and constructs visual and/or audio elements for display to user.
Input: output data from server.
Output: rendered user interface elements on the display and/or audio output.
Terminal creates interface components such as item cards, lists, or map markers, populates them with option names, images, prices, and other attributes, and places the recommendation text in a readable area. Terminal may also prepare strings for text-to-speech synthesis, adjusting settings based on emotion information if included in the payload.

### Step 17

User reviews the options and optionally selects an option or requests further detail.
User examines the displayed options and listens to or reads the recommendation text, then may choose one option or ask a follow-up question.
Input: visual and audio presentation of options on terminal.
Output: a selection signal or a new voice utterance.
User touches a particular option on the screen or issues a further command such as “Choose the first one” or “Show more details about the second spot,” which terminal captures and forwards as new input to server, thereby triggering another execution of part or all of the processing flow described above.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

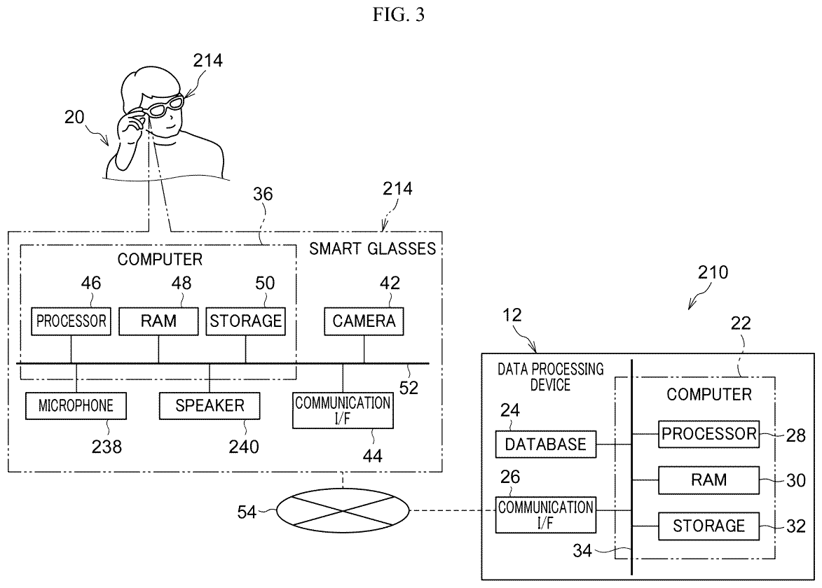

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

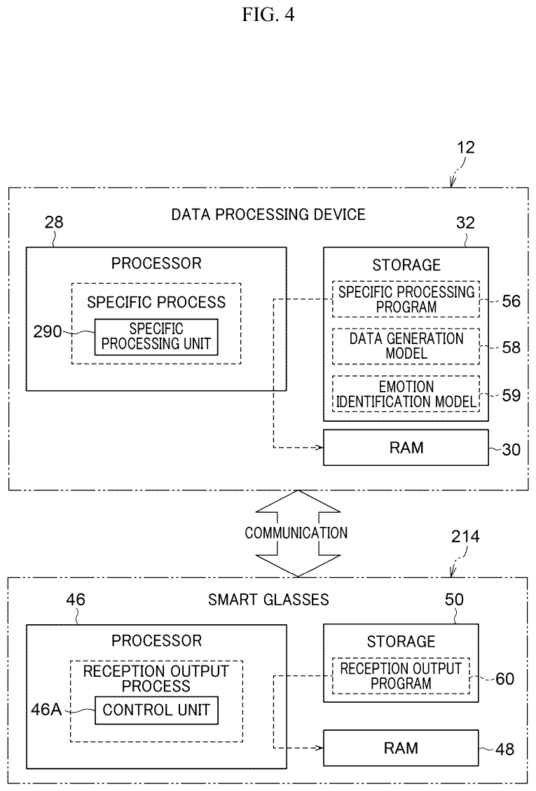

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

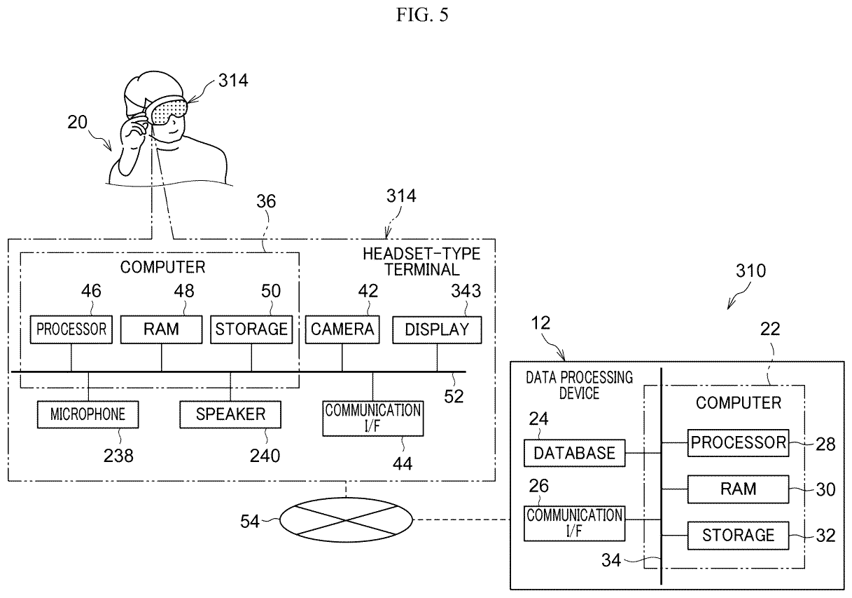

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

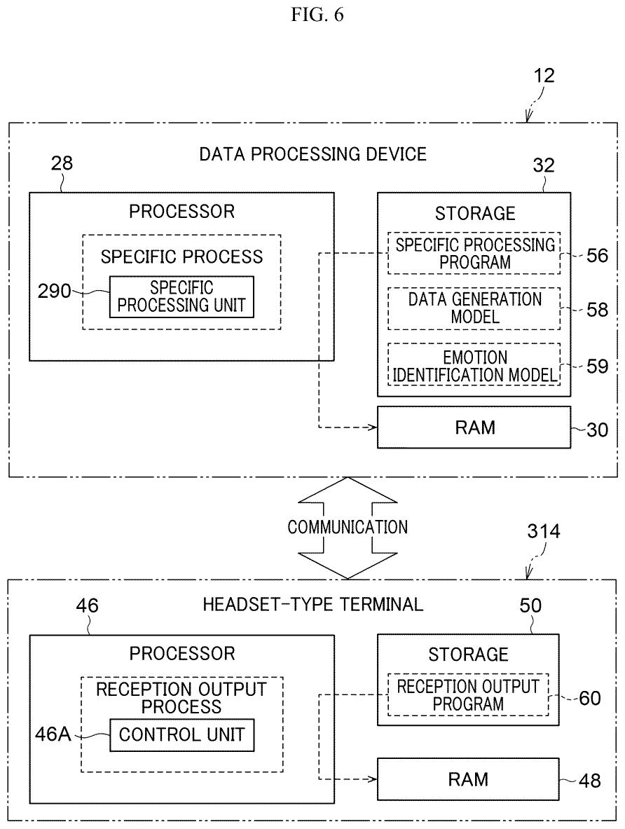

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naíve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

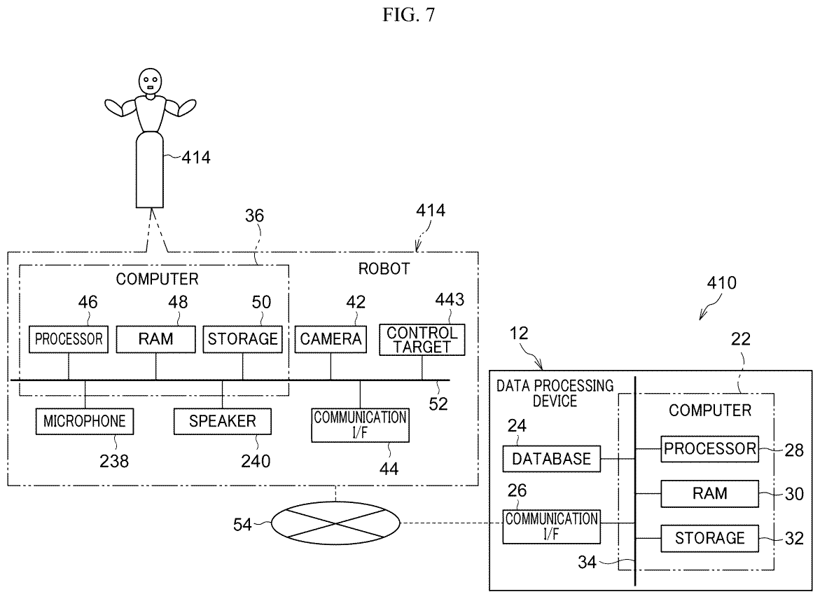

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

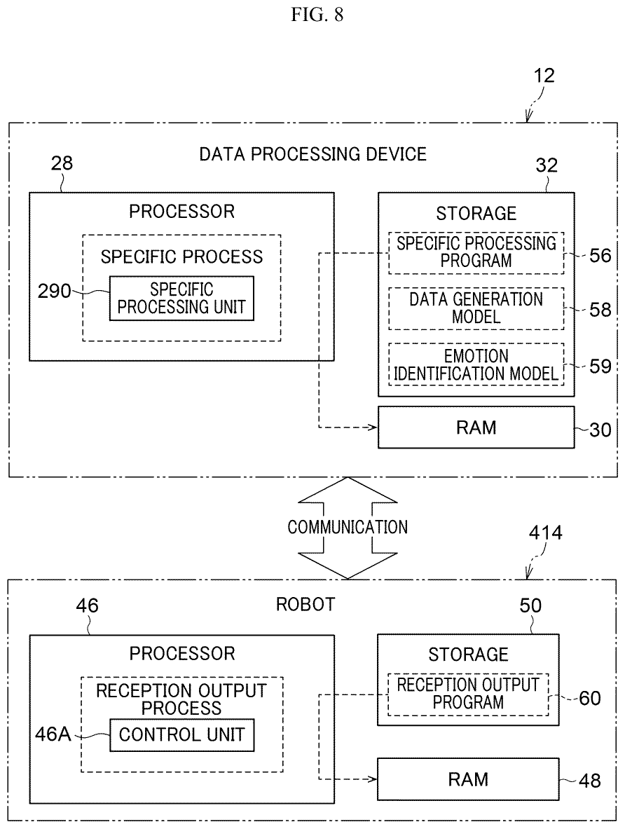

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

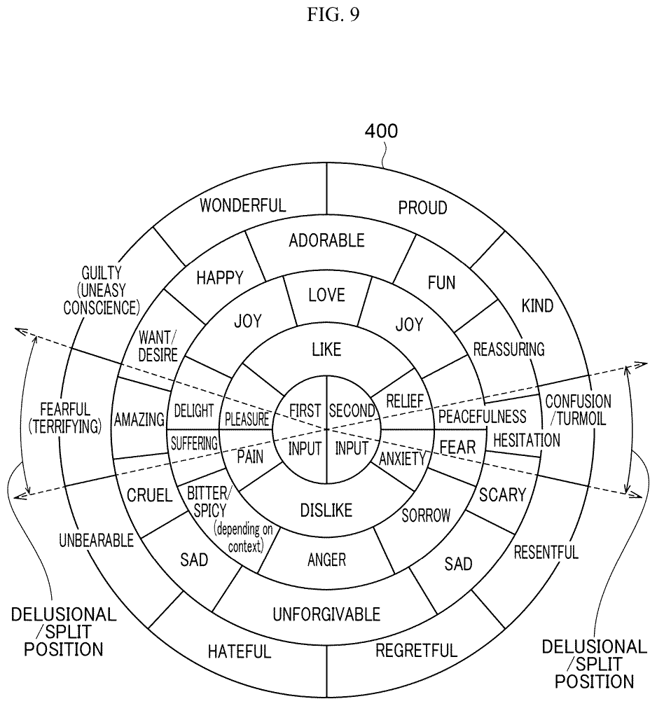

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379. “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

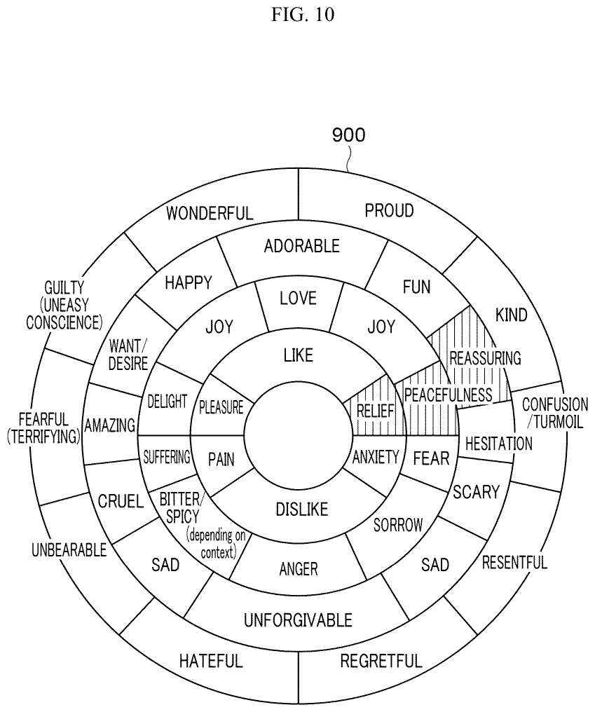

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire a voice input of a user via an acoustic input device and convert the voice input from an analog signal into digital audio data,
transmit the digital audio data via a communication path to an information processing apparatus, input the digital audio data to a speech recognition processing unit in the information processing apparatus, and convert the digital audio data into text data by the speech recognition processing unit,
generate a prompt sentence to be provided to a generative AI model on the basis of the text data, input the prompt sentence to the generative AI model to obtain response data, and determine an optimal option to be provided to the user on the basis of information included in the response data,
present at least one of the response data and the optimal option to the user in a form of character display by a display device or in a form of voice output by a speech synthesis processing unit,
and provide a voice-interactive interface that makes an operation of a character input device by the user unnecessary and that starts and controls a series of processes from acquisition of the voice input to presentation to the user by using only the voice input.

### Supplementary 2

The system according to supplementary 1,
wherein the processor is configured to
control generation of the prompt sentence by adding at least one of user attribute information, spatial location information, and service type information to the text data and inputting the prompt sentence to the generative AI model so as to cause the generative AI model to generate response data suitable for an information providing service or a guidance service for elderly users.

### Supplementary 3

The system according to supplementary 1,
wherein the processor is configured to
combine at least one of an information retrieval processing function, a route guidance processing function, and a facility guidance processing function with a response data generation process by the generative AI model, and generate an integrated information providing result in response to the voice input of the user.

### Application Example 1

### Supplementary 1

A system comprising a processor,
wherein the processor is configured to
acquire voice input of a user and convert the voice input into a digital signal, transmit the digital signal to an information processing apparatus via a communication path, convert the digital signal into a character string by a speech recognition scheme in the information processing apparatus,
extract product information and transaction amount from the character string by a natural language processing scheme,
execute a transaction process by using an electronic payment service based on the product information and the transaction amount,
generate result information understandable for a user including an elderly person based on a result of the transaction process and present the result information to an output device, generate a prompt sentence for a generative information processing model based on the character string and control conditions relating to the transaction process and transmit the prompt sentence to the generative information processing model, and
correct at least one of the product information and the transaction amount or generate the result information based on a response acquired from the generative information processing model.

### Supplementary 2

The system according to supplementary 1,
wherein the processor is configured to
provide a user operation screen that enables the user to specify the product information and the transaction amount by only the voice input without using a character input device as an input device.

### Supplementary 3

The system according to supplementary 1,
wherein the processor is configured to
search product candidates stored in a resource management apparatus based on the product information extracted by the natural language processing scheme and select an optimal product candidate based on at least one of usage history information or attribute information of the user.

### Example 2

### Supplementary 1

A system comprising a processor,
wherein the processor is configured to
acquire speech of a user, sample and quantize the speech to convert the speech into digital audio data, and transmit the digital audio data to a server via a communication unit,
input the digital audio data, at the server, into a speech recognition engine and convert the digital audio data into text data by using the speech recognition engine,
apply a natural language processing algorithm to the text data at the server and extract keywords and phrases from the text data based on part-of-speech information and syntactic information,
execute, at the server, an intent recognition algorithm that estimates, based on the extracted keywords and phrases and the text data, intent information representing an essence of a desire of the user and parameter information associated with the intent information,
obtain, at the server, related information from at least one of an external information source and an internal information source in accordance with the intent information and the parameter information, and determine, based on the related information, at least one of an optimal option and a response content to be presented to the user,
generate, at the server, a prompt sentence for input to a generative model based on meta information including the intent information, the keywords, the phrases, and the related information, and supply the prompt sentence to a generative AI model so as to cause the generative AI model to generate a natural language response sentence, and transmit, from the server to a terminal, at least one of the response sentence generated by the generative AI model and the determined optimal option, and cause the terminal to perform at least one of display output and audio output of the response sentence or the optimal option.

### Supplementary 2

The system according to supplementary 1,
wherein the processor is configured to
provide, at the terminal, a user interface that enables the user to issue a command by speech without using an input device, and execute the processing according to supplementary 1 on speech input acquired via the user interface.

### Supplementary 3

The system according to supplementary 1,
wherein the processor is configured to
generate, based on the intent information and the parameter information, inquiry information to be transmitted to at least one service providing apparatus including an information retrieval apparatus, a location information providing apparatus, a schedule management apparatus, or a transaction support apparatus, transmit the inquiry information to the at least one service providing apparatus, and use information obtained from the at least one service providing apparatus to determine at least one of the optimal option and the response sentence.

### Application Example 2

### Supplementary 1

A system comprising a processor,
wherein the processor is configured to
acquire voice input of a user and convert the voice input into a digital signal,
transmit the digital signal to a speech recognition processing unit and cause the speech recognition processing unit to convert the digital signal into character string data,
apply natural language processing to the character string data to extract words and phrases and generate intent information indicating a desire of the user,
execute emotion analysis processing on the voice input or on the character string data to generate emotion information indicating an emotional state of the user,
search candidate information stored in an information storage unit based on the intent information and the emotion information, evaluate the candidate information, and generate a candidate set,
generate a prompt sentence including the candidate set, the intent information, the emotion information, and user attribute information, and input the prompt sentence to a generative artificial intelligence model to cause the generative artificial intelligence model to generate recommendation information expressed in natural language, and
determine an optimal option to be presented to the user based on the recommendation information and the candidate set, and generate output data representing the optimal option.

### Supplementary 2

The system according to supplementary 1,
wherein the processor is configured to construct the prompt sentence as a document including utterance content of the user, the intent information, the emotion information, the candidate set, and response style specification information, and to use the prompt sentence to instruct the generative artificial intelligence model to generate recommended content.

### Supplementary 3

The system according to supplementary 1,
wherein the processor is configured to use, as the candidate information, an information set including at least one of product information, facility information, route information, and information service information, and to determine the optimal option by combining current position information of the user and past history information of the user with the intent information and the emotion information.

What is claimed is:

1. A system comprising:
circuitry configured to
receive, via a packet-switched network, audio signal data from a terminal device, the audio signal data representing a captured acoustic input from a user,
convert the audio signal data into character sequence data by applying the audio signal data to a signal-to-text conversion module comprising an acoustic model and a language model,
apply a natural language processing algorithm to the character sequence data to extract a keyword set and a phrase set based on part-of-speech classification and syntactic dependency analysis,
generate, based on the character sequence data and the extracted keyword set and phrase set, a structured input sequence for a generative neural network model, the structured input sequence instructing the generative neural network model to produce response data,
acquire the response data from the generative neural network model, and
transmit, via the packet-switched network, a ranked output datum determined from the response data to the terminal device for rendering on a display of the terminal device.

2. The system according to claim 1, wherein the circuitry is further configured to:
execute an intent classification algorithm on the character sequence data and the keyword set and the phrase set to estimate an intent label and associated parameter data representing a request category of the user, and
incorporate the intent label and the associated parameter data into the structured input sequence for the generative neural network model.

3. The system according to claim 2, wherein the circuitry is further configured to:
obtain, based on the intent label and the associated parameter data, related information from at least one of an external data endpoint accessible via the packet-switched network and an internal data repository, and
append the related information to the structured input sequence as context data for the generative neural network model.

4. The system according to claim 3, wherein the external data endpoint provides at least one of an information retrieval service, a route computation service, and a facility lookup service, and wherein the circuitry transmits an inquiry message derived from the intent label and the associated parameter data to the external data endpoint and receives a structured response comprising attribute records.

5. The system according to claim 4, wherein the circuitry is further configured to:
combine the structured response from the external data endpoint with the response data from the generative neural network model to produce an integrated output datum, and
transmit the integrated output datum to the terminal device for at least one of visual rendering on the display and audio rendering via a speech synthesis module of the terminal device.

6. The system according to claim 1, wherein the circuitry is further configured to:
add, to the structured input sequence, at least one of user attribute data, spatial coordinate data received from the terminal device, and service category data, thereby causing the generative neural network model to produce context-adapted response data.

7. The system according to claim 6, wherein the user attribute data comprises at least one of an age group indicator, a language preference indicator, and an accessibility parameter, and wherein the circuitry selects a prompt template from a plurality of stored prompt templates based on the service category data before generating the structured input sequence.

8. The system according to claim 1, wherein the signal-to-text conversion module comprises a neural network acoustic model that receives feature vectors derived from the audio signal data by applying a windowing function, a frequency-domain transform, and a filter bank analysis, and outputs probability distributions over phonetic units that are decoded using a beam search algorithm in combination with the language model.

9. The system according to claim 1, wherein the generative neural network model is a transformer-based language model comprising an embedding layer, a plurality of self-attention layers, and feedforward layers, and wherein the circuitry encodes the structured input sequence into token identifiers that are processed through the plurality of self-attention layers to produce the response data in an auto-regressive token generation process.

10. The system according to claim 1, wherein the circuitry is further configured to:
apply an affective state classifier to at least one of acoustic feature data derived from the audio signal data and semantic feature data derived from the character sequence data to generate an affective state label indicating an emotional condition of the user, and
incorporate the affective state label into the structured input sequence, thereby causing the generative neural network model to adjust a characteristic of the response data based on the affective state label.

11. The system according to claim 10, wherein the affective state classifier comprises a neural network that receives at least one of pitch data, energy data, and spectral coefficient data extracted from the audio signal data, and outputs probability scores for a plurality of predefined affective state categories.

12. The system according to claim 1, wherein the circuitry is further configured to:
search candidate data records stored in a data repository based on the keyword set and the phrase set,
compute a relevance score for each candidate data record based on attribute similarity to the keyword set, and
select a subset of the candidate data records having relevance scores exceeding a threshold as a candidate set included in the structured input sequence for the generative neural network model.

13. The system according to claim 12, wherein the circuitry is further configured to:
acquire, from the generative neural network model, recommendation data expressed in natural language that references one or more candidate data records from the candidate set, and
determine the ranked output datum by combining the relevance scores with indicators extracted from the recommendation data.

14. The system according to claim 13, wherein the candidate data records comprise at least one of product attribute records, facility attribute records, route attribute records, and service description records, and wherein the relevance score computation further incorporates at least one of spatial proximity data and user interaction history data.

15. The system according to claim 1, wherein the circuitry provides an interaction interface that initiates and controls a processing pipeline from acquisition of the audio signal data through transmission of the ranked output datum using only the audio signal data as a trigger, without requiring character input device operation by the user.

16. The system according to claim 1, wherein the circuitry is further configured to:
receive, via the packet-switched network, image frame data from an image acquisition device of the terminal device,
apply a convolutional neural network-based expression classification model to the image frame data to determine an expression label, and
incorporate the expression label into the structured input sequence for the generative neural network model.

17. The system according to claim 1, wherein the circuitry is further configured to:
store, in the data repository, a session record comprising the character sequence data, the structured input sequence, the response data, and the ranked output datum, and
update prompt generation parameters based on aggregated session records to reduce a number of tokens required for the generative neural network model to produce relevant response data.

18. A system comprising:
circuitry configured to
receive, via a packet-switched network, audio signal data from a terminal device,
convert the audio signal data into character sequence data using a signal-to-text conversion module,
apply a natural language processing algorithm to the character sequence data to extract a keyword set and a phrase set,
execute an intent classification algorithm on the character sequence data and the keyword set and the phrase set to produce an intent label and parameter data,
apply an affective state classifier to at least one of the audio signal data and the character sequence data to produce an affective state label,
search candidate data records in a data repository based on the intent label, the parameter data, and the affective state label to generate a candidate set,
generate a structured input sequence for a generative neural network model, the structured input sequence comprising the candidate set, the intent label, the affective state label, and user attribute data,
acquire recommendation data from the generative neural network model based on the structured input sequence,
determine a ranked output datum from the candidate set based on the recommendation data, and
transmit, via the packet-switched network, the ranked output datum to the terminal device.

19. The system according to claim 18, wherein the circuitry is further configured to:
construct the structured input sequence as a composite document comprising a representation of an utterance of the user, the intent label, the affective state label, attribute descriptions of the candidate set, and a response style specification, and
instruct the generative neural network model via the structured input sequence to generate the recommendation data in a format that references specific candidate data records from the candidate set.

20. A method performed by a system comprising circuitry, the method comprising:
receiving, via a packet-switched network, audio signal data from a terminal device, the audio signal data representing a captured acoustic input from a user;
converting the audio signal data into character sequence data by applying the audio signal data to a signal-to-text conversion module comprising an acoustic model and a language model;
applying a natural language processing algorithm to the character sequence data to extract a keyword set and a phrase set based on part-of-speech classification and syntactic dependency analysis;
generating, based on the character sequence data and the extracted keyword set and phrase set, a structured input sequence for a generative neural network model, the structured input sequence instructing the generative neural network model to produce response data;
acquiring the response data from the generative neural network model; and
transmitting, via the packet-switched network, a ranked output datum determined from the response data to the terminal device for rendering on a display of the terminal device.
